(19) United States
(12) Patent Application Publication
(10) Pub. No.: US 2005/0239536 A1
(43) Pub. Date: Oct. 27, 2005

(54) Gaming machine

(75) Inventor: Takahiro Ogiwara, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/108,894

(22) Filed: Apr. 19, 2005

(30) Foreign Application Priority Data
Apr. 22, 2004 (JP) P2004-126772
Apr. 22, 2004 (JP) P2004-126781

(51) Int. Cl. A63F 13/00

(52) U.S. Cl. 463/17; 463/16

(57) ABSTRACT

A player switches display between a first BET screen 131 provided with a usual table betting board 30 and a second BET screen 133 provided with a Loto-type number selection betting board 132 by pressing a screen switch button 34, 46. In a roulette game using the second BET screen 133, the player predicts the three lottery results including the current lottery result on a roulette wheel 3 and selects three numbers. Further, after the lottery, how many of the three selected numbers match the win numbers is determined, and a predetermined amount of credit points are paid out based on the match number count (the number of identical number pairs).

### CROSS-REFERENCE TO THE RELATED APPLICATION(S)

The application is based upon and claims a priority from prior Japanese Patent Applications No. 2004-126772 and No. 2004-126781 both filed on Apr. 22, 2004, the entire contents of which are incorporated herein by reference.

### BACKGROUND OF THE INVENTION

1. Field of the Invention

The present invention relates to a gaming machine for drawing a lottery of symbols using a roulette wheel and for a player to predict a result of the lottery, and in particular to a gaming machine that provides a wide variety of games for the player in addition to conventional games.

2. Description of the Related Art

A so-called medal game played by a player using medals as game media, the medal game provided by a gaming machine such as a roulette gaming machine, is a game that is started as the player purchases or borrows a plurality of medals with a medal lending machine and inputs the medal into the gaming machine. When the player wins the game, a predetermined number of medals are paid out to the player. Therefore, the player who gains a large number of medals enjoys continuously playing the game without purchasing or borrowing new medals. Particularly in the roulette gaming machine, the player plays a game by betting the medal purchased or borrowed with the medal lending machine on a symbol from which the player expects a win.

Hitherto, with the roulette gaming machine, a game has been played using a betting board displayed on a monitor display as shown in JP-A-2003-325726. A plurality of numbers (also containing letters) placed on a roulette wheel as the symbols are arranged in grids on the betting board. The player predicts the number on which a ball rotating on the roulette wheel would finally stop in the current game, and bets chips each of which corresponds to the medal on the specified area. When the player wins the game in the bet area, chips are paid out to the player in accordance with the number of the chips bet and a predetermined multiplication.

### SUMMARY OF THE INVENTION

However, in the roulette gaming machine described in JP-A-2003-325726, the player only predicts one number on which the ball will finally stop on the roulette wheel in the current game, and the game result is not associated with the later lottery result of the roulette wheel. That is, the steps of “betting chips by the player,” “lottery on the roulette wheel,” and “paying out chips” are repeated in the related art and thus that repeating of the steps may make the game monotonous, making the player lose interest in the game. In the bet method using the betting board in the related art, the bet patterns are limited and the number of chips to be paid out (odds) when the ball stops on the number that the player predicts is limited.

It is therefore one of objects of the invention to provide a gaming machine for increasing the variety of game plays and enabling the player to continue having interest in the game by providing the player with a game of a Loto-type game or a Numbers-type game for paying out chips according to odds at high rate while performing the same lottery processing with the same roulette wheel of the related art.

According to a first aspect of the invention, there is provided a gaming machine including: a roulette wheel on which a plurality of symbols are arranged; a symbol lottery unit that draws a lottery to determine a win symbol from among the symbols arranged on the roulette wheel; a betting section that allows a player to bet on at least one of the symbols arranged on the roulette wheel; a first game processing unit that provides a first game of a roulette game to the player, the first game processing unit determining whether or not the symbol on which the player bet with the betting section matches with the win symbol determined by the symbol lottery unit in a single round of the lottery; and a second game processing unit that provides a second game different from the first game to the player, the second game being played in accordance with the symbol on which the player bet with the betting section and the win symbol determined by the symbol lottery unit.

According to a second aspect of the invention, there is provided a gaming method including: drawing a lottery to determine a win symbol from among a plurality of symbols arranged on a roulette wheel; allowing a player to bet on at least one of the symbols arranged on the roulette wheel; providing a first game of a roulette game to the player, the first game being played by determining whether or not the symbol on which the player bet matches with the win symbol; and providing a second game different from the first game to the player, the second game being played in accordance with the symbol on which the player bet and the win symbol.

### BRIEF DESCRIPTION OF THE DRAWINGS

These and other objects and advantages of the present invention will be more fully apparent from the following detailed description taken in conjunction with the accompanying drawings, in which:

FIG. 1 is an external perspective view to show the schematic configuration of a roulette gaming machine according to a first embodiment of the invention;

FIG. 2 is a plan view of a roulette wheel according to the first embodiment;

FIG. 3 is a drawing to show an example of a display screen displayed on an image display;

FIG. 4 is a drawing to show an example of a display screen displayed on the image display;

FIG. 5 is a schematic drawing to show a bet display section of a second BET screen according to the first embodiment;

FIG. 6 is a schematic drawing to show a bet result display section of the second BET screen according to the first embodiment;

FIG. 7 is a drawing to show an award table according to the first embodiment;

FIG. 8 is a perspective view to show a medal acceptance unit according to the first embodiment;

FIG. 9 is a block diagram to schematically show a control system of the roulette gaming machine according to the first embodiment;

FIG. 10 is a block diagram to schematically show a control system of a satellite according to the first embodiment;

FIG. 11 is a schematic drawing to show storage areas of ROM of the roulette gaming machine according to the first embodiment;

FIG. 12 is a schematic drawing to show storage areas of RAM of the roulette gaming machine according to the first embodiment;

FIG. 13 is a flowchart of a usual roulette game processing program according to the first embodiment;

FIG. 14 is a flowchart of a Loto-type roulette game processing program according to the first embodiment;

FIG. 15 is a drawing to show an example of a display screen displayed on an image display in a second embodiment of the invention;

FIG. 16 is a drawing to show an example of a display screen displayed on the image display in the second embodiment;

FIG. 17 is a schematic drawing to show a bet display section of a second BET screen according to the second embodiment;

FIG. 18 is a schematic drawing to show a bet result display section of the second BET screen according to the second embodiment;

FIG. 19 is a drawing to show an award table according to the second embodiment; and

FIG. 20 is a flowchart of a Numbers-type roulette game processing program according to the second embodiment.

### DETAILED DESCRIPTION OF THE PREFERRED EMBODIMENTS

A gaming machine according to the invention will be discussed in detail with reference to the accompanying drawings based on embodiments of a roulette gaming machine 1 as the gaming machine to which the invention is applied.

### First Embodiment

The roulette gaming machine 1 is a gaming machine in which a player predicts a symbol such as a number or a character determined with rotation of a roulette wheel and bets desired credit points owned by the player on the predicted symbol, and when a ball stops on the symbol on which the credit points are bet, the player receives payout of a predetermined number of credit points. The credit points are gained by winning the game or by inputting game media such as medals and coins into the roulette gaming machine 1.

The plurality of symbols arranged on the roulette wheel may be arbitrary as far as each of the symbols can be discriminated from one another, and each of the symbols may be configured to have attribute including any of a plurality of numbers, a plurality of characters, a plurality of icons or figures, and a plurality of colors. In the following description, it is assumed that the symbols arranged on the roulette wheel have attribute of a plurality of numbers different from one another.

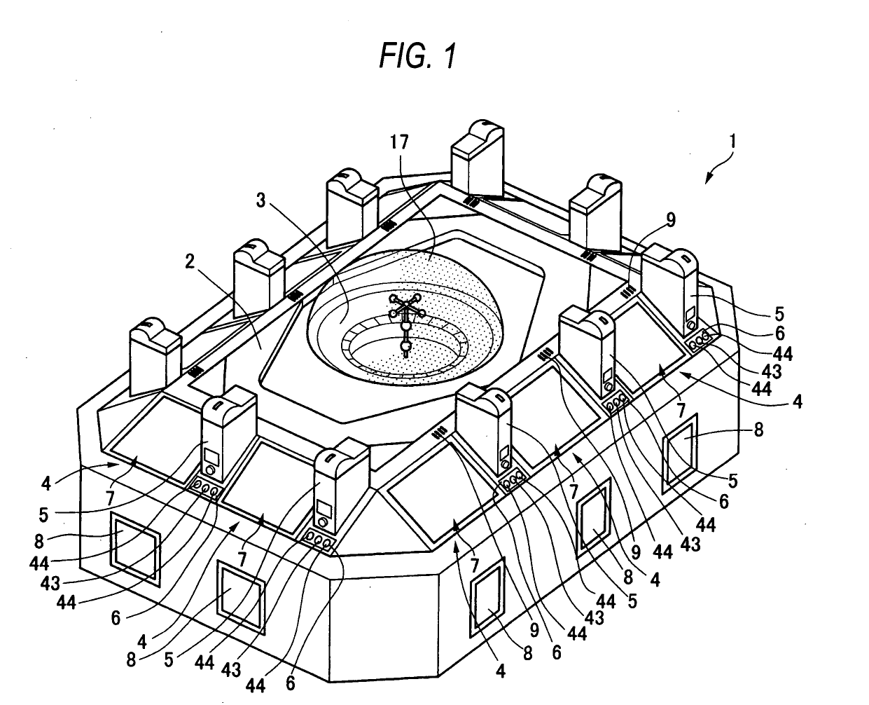

A schematic configuration of the roulette gaming machine 1 according to the first embodiment will be described with reference to FIG. 1. FIG. 1 is an external perspective view to show the schematic configuration of the roulette gaming machine 1 according to the first embodiment.

As shown in FIG. 1, the roulette gaming machine 1 basically includes a cabinet 2 of a main body, a roulette wheel 3 provided substantially in the center of the top face of the cabinet 2, and a plurality of (in the first embodiment, ten) satellites (betting section) 4 placed so as to surround the roulette wheel 3.

The satellite 4 refers to a place to play a game and includes at least a medal acceptance unit (game media acceptance unit) 5 for inputting game media such as coins and medals for playing the game, a control section 6 including control buttons operated by the player to enter commands, and an image display (display unit) 7 for displaying an image involved in the game. The player operates the control section 6 while seeing the image displayed on the image display 7, to thereby play the game provided in the roulette wheel 3 and the image display 7.

Medal payout openings 8 are provided on the sides of the cabinet 2 where the satellites 4 are installed. A speaker 9 for producing music and effect sound is provided in the upper right portion of the image display 7 of each satellite 4.

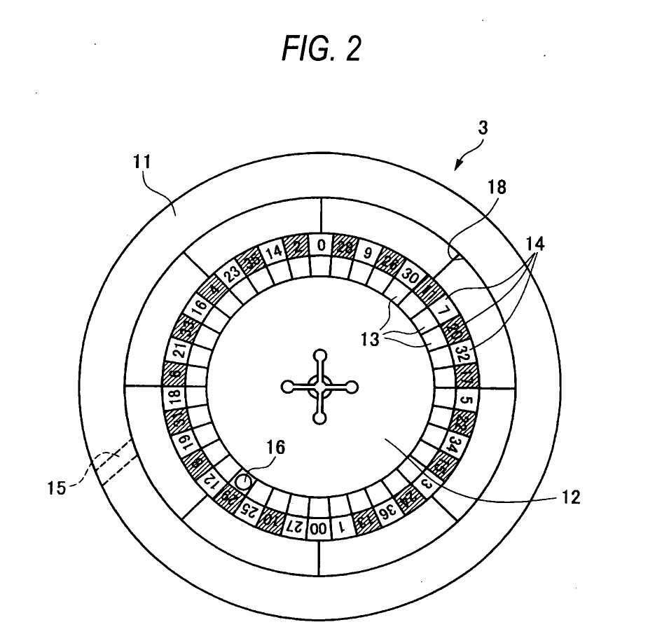

The configuration of the roulette wheel 3 according to the first embodiment will be discussed with reference to FIG. 2. FIG. 2 is a plan view of the roulette wheel 3 according to the first embodiment.

As shown in FIG. 2, the roulette wheel 3 basically includes a frame 11 fixed to the cabinet 2 and a rotation disk 12 housed and supported inside of the frame 11 for rotation. The rotation disk 12 is formed on the top face with a large number of (in the first embodiment, thirty-eight) concave ball housing grooves 13. Number indication plates 14 indicating numbers of “0,” “00,” and “1” to “36” as graphic characters in a one-to-one correspondence with the ball housing grooves 13 are formed on the top face of the rotation disk 12 in the outer direction of the ball housing grooves 13.

A ball discharging port 15 is formed in the frame 11. A ball discharging unit (not shown) is joined to the ball discharging port 15 and a ball 16 is discharged onto the rotation disk 12 from the ball discharging port 15 by the ball discharging unit. The whole above the roulette wheel 3 is covered with a transparent acrylic cover member 17 substantially shaped in a hemispheric shape.

The frame 11 is inclined gently to the center and is formed in an intermediate portion with a guide wall 18 for guiding the discharged ball 16 against the centrifugal force and rolling the ball 16. As the rotation speed reduces and the centrifugal force is lost, the ball 16 rolls down the slope of the frame 11 and goes to the inside thereof and arrives at the rotating rotation disk 12.

The ball 16 rolling to the rotation disk 12 is housed in one of the ball housing groove 13 through the tops of the number indication plates 14 outside the rotating rotation disk 12, and the number described on the number indication plate 14 corresponding to the ball housing groove 13 in which the ball 16 is housed becomes the win number.

A win determination unit (not shown) is installed below the roulette wheel 3 for determining which number the ball is housed in the ball housing groove 13 corresponding thereto. Further, a ball collection unit is installed below the rotation disk 12 for collecting the ball 16 on the rotation disk 12 after each game is over. The ball discharging unit, the win determination unit, and the ball discharging unit are conventionally well known in the art and therefore will not be discussed in detail.

The configurations of the control section 6 and the image display 7 according to the first embodiment will be discussed.

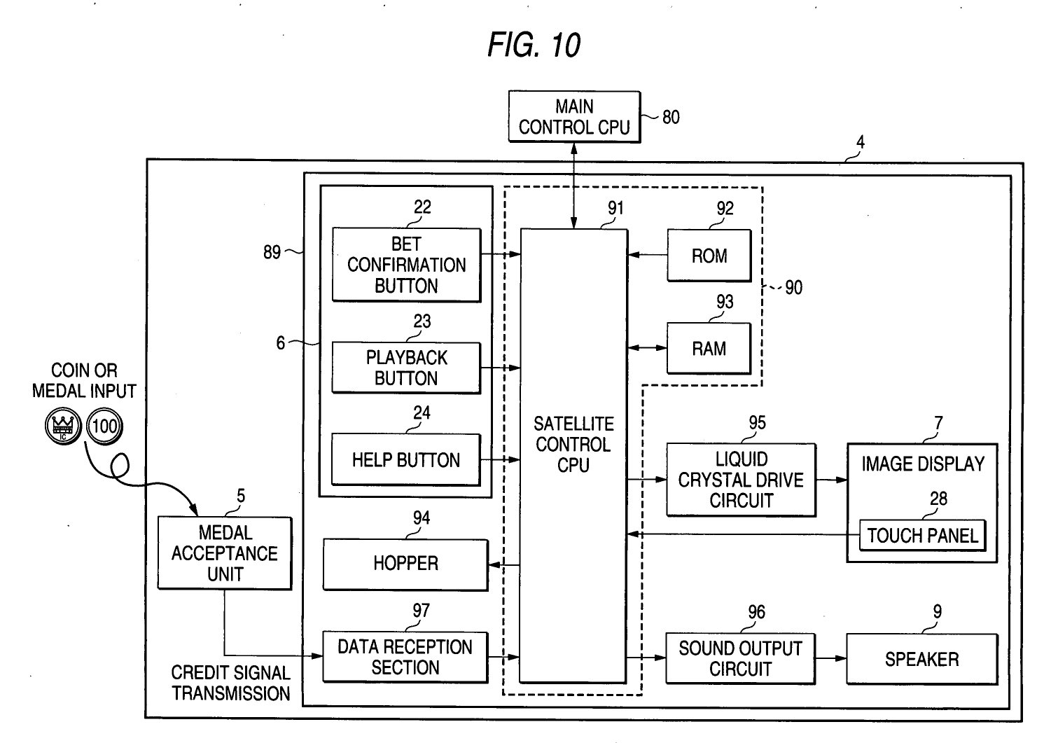

The control section 6 is provided on the side of the image display 7 of the satellite 4 and buttons operated by the player are placed, as shown in FIGS. 1 and 10. Specifically, a BET confirmation button 22, a payback (CASHOUT) button 23, and a help (HELP) button 24 are placed from the left to the right viewed from the position opposed to the satellite 4.

The BET confirmation button 22 is a button pressed by the player to confirm the bet after bet operation with the image display 7 described later. When the bet is confirmed and the player bets a chip on the number described on the number indication plate 14 corresponding to the ball housing groove 13 in which the ball 16 is housed on the roulette wheel 3 during the gaming, the player wins the game. When the player wins the game, credit points responsive to the number of the chips bet are added to the current owned credit points of the player. The bet operation is described later in detail.

The payback button 23 is a button to be pressed by the player when the player decides to end playing the game. When the player presses the payback button 23, medals responsive to the current owned credit points of the player, gained by the games, (usually, one medal to one credit points) are paid back to the player from the medal payout opening 8.

The help button 24 is a button to be pressed by the player when the player is unfamiliar with the rules and operation to play the game. When the player presses the help button 24, immediately a held screen indicating various pieces of operation information is displayed on the image display 7.

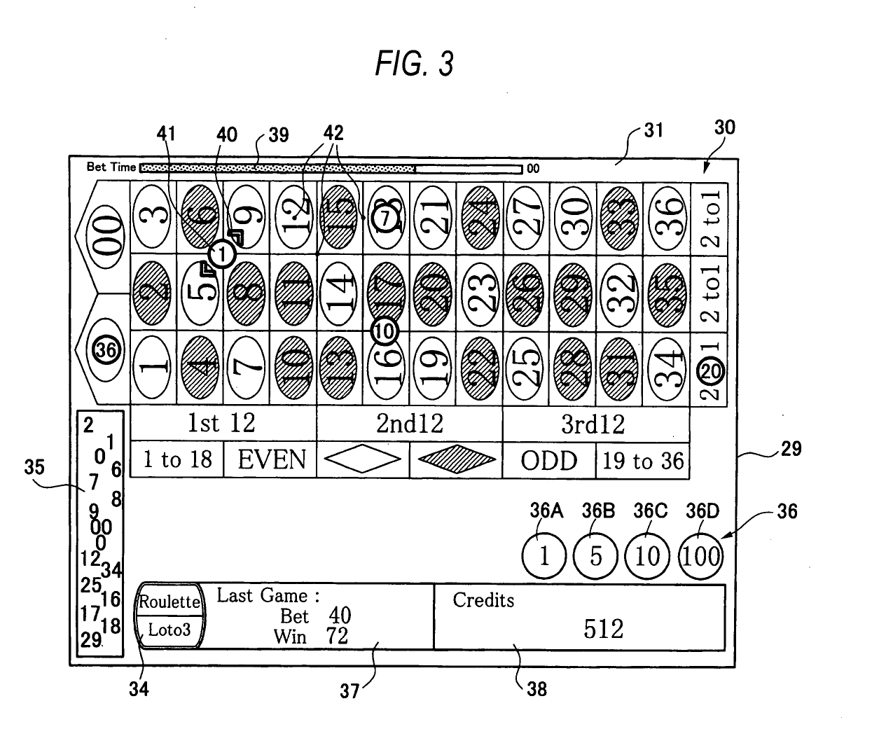

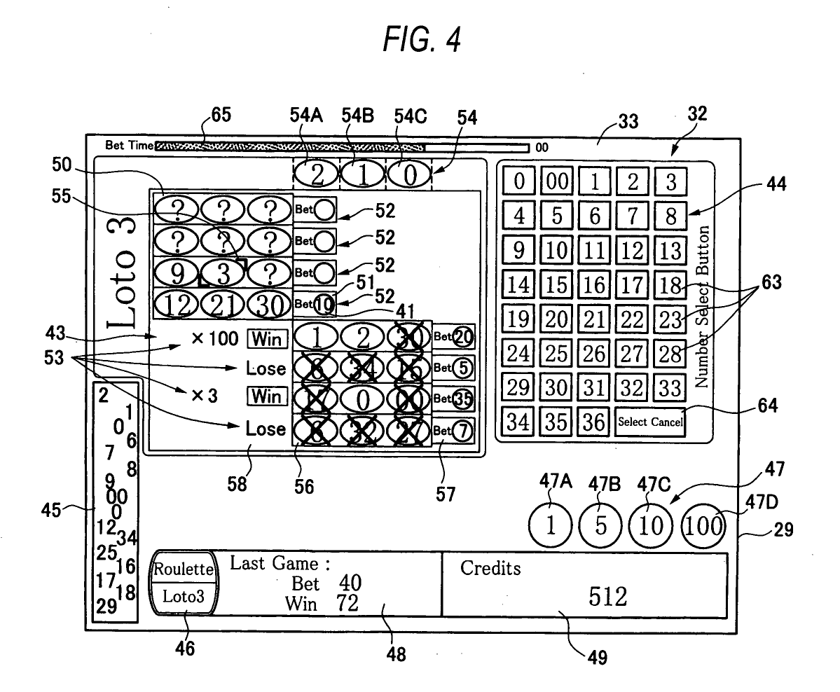

The image display 7 is a touch-panel liquid crystal display with a touch panel 28 attached to the front of the liquid crystal display. The player presses an icon displayed on a liquid crystal screen 29 with a finger to select the icon. FIGS. 3 and 4 are drawings to show examples of display screens displayed on the image display 7 during the gaming.

As shown in FIGS. 3 and 4, during the gaming with the roulette gaming machine 1, the image display 7 displays two types of screens of a first BET screen (a first game screen) 31 having a usual table-type betting board 30 for allowing the player to predict the win number only in the current game (only in a single round of the lottery) and a second BET screen (a second game screen) 33 having a Loto-type number selection betting board 32 for allowing the player to predict the win numbers in a total of three lotteries (three rounds of the lottery) at a time. The display of the image display 7 is switched between the first BET screen 31 and the second BET screen 33 each time a screen switch button 34, 46 displayed on the liquid crystal screen 29 is pressed. After selecting either of the first BET screen 31 and the second BET screen 33, the player bets chips using the credit points owned by the player.

First, the first BET screen 31 will be discussed based on FIG. 3. The same numbers as the numbers “0,” “00,” and “1” to “36” indicated on the number indication plates 14 are arranged in grids on the table betting board 30 displayed on the first BET screen 31. Special BET areas for the player to bet a chip by specifying “odd number,” “even number,” “color of number indication plate (red or black), “or “given number range (for example, “1 to 12”, “13 to 24” or the like)” are also arranged in grids.

Displayed at a lower portion in the table betting board 30 are a result history display section 35, the above-mentioned screen switch button 34, betting unit selection buttons 36, a payback result display section 37, and a credit points display section 38 from the left to the right of the screen.

The result history display section 35 lists the results of the win numbers in the previous games (one game refers to an operation sequence from the player betting a chip at each satellite 4 to the ball 16 dropping to the ball housing groove 13 to paying out credit based on the win number). When one game is over, a new win number is added to the top of the result history display section 35 to allow the player to check the history of the win numbers of a maximum of 16 games.

The screen switch button 34 is a button for switching between the first BET screen 31 and the second BET screen 33 displayed on the image display 7 as mentioned above. Two character strings of “Roulette” and “Loto3” are displayed on the screen switch button 34. If the player presses the screen switch button 34 on the liquid crystal screen 29, the first BET screen 31 using the table betting board 30 can be switched to the second BET screen 33 using the number selection betting board 32 for display. Then, the player bets a chip based on the betting board on the current displayed screen.

The betting unit selection buttons 36 are buttons for allowing the player to bet chips on a BET area 42 (within a grid provided with numbers or characters or on a line forming the grid) specified by the player. The following four types of betting unit selection buttons 36 are included: 1-BET button 36A, 5-BET button 36B, 10-BET button 36C, and 100-BET button 36D.

The player first specifies the BET area 42 with a cursor 40 described later by directly pressing the screen with a finger, etc. When the player presses the 1-BET button 36A, one chip is bet at a time (the number of bet chips increases such as “1”->“2”->“3” and so on each time the player presses the 1-BET button 36A with a finger). When the player presses the 5-BET button 36B, five chips are bet at a time (the number of bet chips increases such as “5”->“10”->“15” and so on each time the player presses the 5-BET button 36B with a finger). When the player presses the 10-BET button 36C, 10 chips are bet at a time (the number of bet chips increases such as “10”->“20”->“30” each time the player presses the 10-BET button 36C with a finger) When the player presses the 100-BET button 36C, 100 chips are bet at a time (the number of bet chips increases such as “100”->“200”->“300” and so on each time the player presses the 100-BET button 36D with a finger).

According to the above configuration, the betting operation can be simplified when betting a large number of chips.

The payback result display section 37 displays the number of bet chips of the player in the preceding game and the credit points to be paid-back (paid-back credit points). Here, subtracting the number of bet chips from the paid-back credit points results in the credit points newly gained by the player in the preceding game.

The credit points display section 38 displays the credit points presently owned by the player. When the player bets chips, the credit points is decremented by the number of the bet chips (one credit points per chip). If the player wins the game and the corresponding credit points are paid back, the credit points is incremented by the paid-back credit points. When the credit points owned by the player reaches 0, the game is over.

A BET timer graph 39 is provided at the upper portion of the table betting board 30. The BET timer graph 39 is a graph for indicating the remaining time during which the player is allowed to bet, and a red graph extends gradually to the right with the passage of time from the game start time. When the graph extends to the rightmost side, the time during which the player can bet in the current game expires. When the bet period of the player at each satellite 4 expires, namely, when the BET timer graph 39 reaches the rightmost side, the ball discharging unit discharges the ball 16 into the roulette wheel 3.

A cursor 40 indicating the BET area 42 presently selected by the player is displayed on the table betting board 30. A chip mark 41 indicating the number of chips bet and the selected BET area 42 so far is also displayed on the table betting board 30. The number displayed on the chip mark 41 denotes the number of chips bet. For example, the chip mark 41 displayed with a number “7” thereon placed on the grid “18” as shown in FIG. 3 indicates that the player bets seven chips on the number “18”. The betting method in which to bet a chip on a single number is called “straight up.”

The chip mark 41 displayed with a number “1” thereon placed at the intersection of the grids “5,” “6,” “8,” and “9” indicates that the player bets one chip on the four numbers covering “5,” “6,” “8,” and “9”. The betting method in which to bet a chip covering four numbers is called “corner bet.”

Other available betting methods are as follows: “Split bet” is a betting method in which to bet a chip covering two numbers on the line between two numbers (adjacent grids); “street bet” is a betting method in which to bet a chip covering three numbers (for example, “13,” “14,” and “15”) on the end of a horizontal row of the numbers (in FIG. 3, one row in the vertical direction); “five bet” is a betting method in which to bet a chip covering five numbers of “0,” “00,” “1,” “2,” and “3” on the line between the numbers “00” and “3”; “line bet” is a betting method in which to bet a chip covering six numbers (for example, “13,” “14,” “15,” “16,” “17,” and “18”) among numbers of two horizontal rows of the numbers (in FIG. 3, two rows in the vertical direction); “column bet” is a betting method in which to bet a chip covering 12 numbers on the grid written as “2 to 1;” and “dozen bet” is a betting method in which to bet a chip covering 12 numbers on the grid written as “1st 12,” “2nd 12,” or “3rd 12.” Further, betting methods each covering 18 numbers depending on the number indication plate color (red or black), odd or even number, whether the number is equal to or less than 18 or is equal to or more than 19 using six grids provided at the bottom stage of the table betting board 30 are also available. The betting methods differ in credit award (odds) per chip when the player wins the game in betting the chip (chips).

To bet a chip on the first BET screen 31 described above, first the player specifies the BET area 42 (within a grid of a number or a character or on a line forming the grid) to bet on the screen and presses the BET area 42 directly with a finger. Consequently, the cursor 40 moves to the specified BET area 42.

Then, whenever the player presses one of the betting unit selection buttons 36 (1-BET button 36A, 5-BET button 36B, 10-BET button 36C, 100-BET button 36D), as many chips as the number indicated by the betting unit selection button are bet on the specified BET area 42. For example, when the player presses the 10-BET button 36C four times, the 5-BET button 36B once, and the 1-BET button 36A three times, a total of 48 chips is bet.

Next, the second BET screen 33 will be discussed with reference to FIG. 4. With the second BET screen 33, the player uses the number selection betting board 32 to play a Loto-type roulette game for predicting the win numbers in a total of three lotteries including the current lottery at a time.

The number selection betting board 32 displayed on the second BET screen 33 basically includes a selection result display section 43 for displaying the selected numbers, and a number selection section 44 pressed by the player for selecting a number. Displayed at a lower portion of the number selection betting board 32 are a result history display section 45, the above-mentioned screen switch button 46, betting unit selection buttons 47, a payback result display section 48, and a credit points display section 49 as with the first BET screen 31 described above.

The selection result display section 43 displays the three numbers selected by the player through the number selection section 44, the number of bet chips, and the lottery result. Specifically, the selection result display section 43 includes a plurality of substantially rectangular bet display sections 52 each including a selected number display section 50 for displaying the three numbers selected by the player and a number-of-chips display section 51 for displaying the number of bet chips and a plurality of bet result display sections 53 for indicating information concerning the previous bets of the player with the win or loss result confirmed in the preceding game in the same format as the bet display sections 52, as shown in FIG. 4.

A result number display section 54 indicating the three win numbers with the roulette wheel 3 in the past is provided above the bet display sections 52.

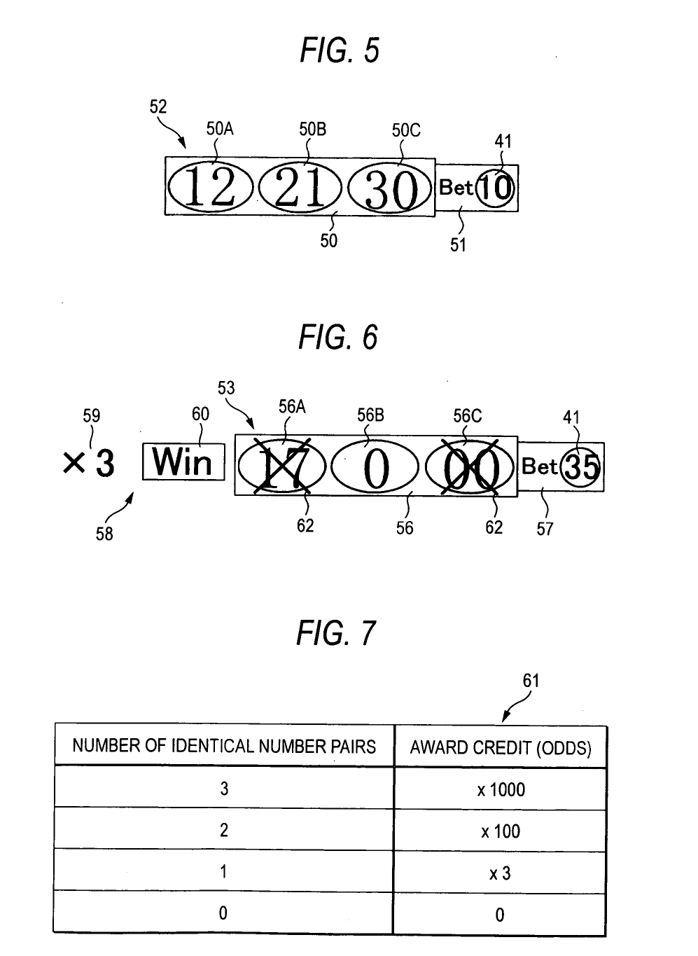

The bet display sections 52 will be discussed. FIG. 5 is a schematic drawing to show the bet display section of the second BET screen according to the first embodiment.

The selected number display section 50 of the bet display section 52 is provided with three display sections of a first selected number display section 50A, a second selected number display section 50B, and a third selected number display section 50C from the left to the right facing the liquid crystal screen 29. The three numbers selected by the player using the number selection section 44 are displayed on the selected number display sections 50A to SOC.

Before numbers are selected, “?” marks are displayed on the selected number display sections 50A to 50C as shown in FIG. 4. The player selects any of the selected number display sections 50A to 50C using a cursor described below and selects any numbers through the number selection section 44, whereby the player-selected numbers are displayed on the selected number display sections 50A to 50C.

The number-of-chips display section 51 of the bet display section 52 displays the chip mark 41 indicating the number of bet chips on the three numbers selected in the selected number display section 50. The number displayed on the chip mark 41 indicates the number of chips bet. For example, as shown in FIG. 4, when three numbers of “12,” “21,” and “30” are displayed on the selected number display sections 50A to 50C and the chip mark 41 indicating “10” is displayed on the number-of-chips display section 51, it means that 10 chips are bet on the numbers “12,” “21,” and “30”. Three lotteries are drawn with the roulette wheel 3 including the current lottery and when the three obtained win numbers and the three selected numbers match, credit points is paid out to the player based on the number of identical number pairs.

Next, the bet result display sections 53 will be discussed. The bet result display section 53 indicates information concerning the bet of the player with the win or loss result confirmed in the preceding game. FIG. 6 is a schematic drawing to show the bet result display section of the second BET screen according to the first embodiment.

The bet result display section 53 has a similar composition to that of the bet display section 52 and is provided with a selected number display section 56 and a number-of-chips display section 57. Further, the bet result display section 53 is provided with a win result display section 58 for indicating whether or not the three numbers selected by the player in the selected number display section 56 match the three win numbers as the lottery results with the roulette wheel 3 to the left of the selected number display section 56.

The selected number display section 56 is provided with three display sections of a first selected number display section 56A, a second selected number display section 56B, and a third selected number display section 56C from the left to the right facing the liquid crystal screen 29. The three numbers previously selected by the player using the number selection section 44 are displayed on the selected number display sections 56A to 56C.

An “X” mark 62 is displayed additionally to the selected number display sections 56A to 56C where the displayed number in each of the selected number display sections 56A to 56C does not match any win numbers obtained from the lottery results with the roulette wheel 3 in the three past lotteries (three numbers displayed in the result number display section 54), as shown in FIG. 6.

When the “X” mark 62 is displayed in all of the selected number display sections 56A to 56C, namely, when none of the numbers selected by the player match the win numbers obtained from the lottery results with the roulette wheel 3 in the past three lotteries (three numbers displayed in the result number display section 54), a character string of “Lose” is displayed in the win result display section 58. In this case, award of credit points is not paid out to the player and the chips bet and displayed on the number-of-chips display section 57 are lost.

On the other hand, when no “X” mark 62 is displayed in any one of the selected number display sections 56A to 56C, namely, when any of the numbers selected by the player matches one of the win numbers obtained from the lottery results with the roulette wheel 3 in the three past lotteries (three numbers displayed in the result number display section 54), a character string 60 of “Win” is displayed on the win result display section 58. Further, credit points to be awarded to the player (award credit points, or odds) 59 responsive to the number of the identical number pairs is displayed to the side of the character string 60.

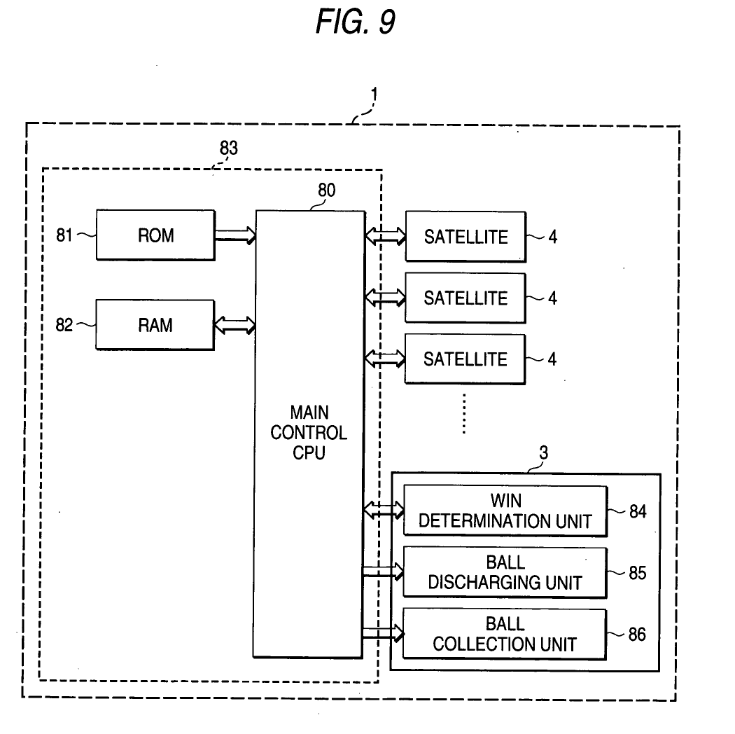

The award credit (odds) 59 is determined according to an award table 61 stored in ROM 81 later described with reference to FIG. 9. FIG. 7 is a drawing to show the award table 61 according to the first embodiment.

As shown in FIG. 7, the award credit (odds) paid out to the player in response to the number of identical number pairs is uniquely determined in the award table 61. Specifically, when all of the three numbers selected by the player in the selected number display section 56 match the three win numbers, credit points as many as 1000 times of the chips bet in the number-of-chips display section 57 is paid out and is added to the current credit points owned by the player. When two of the three numbers selected by the player in the selected number display section 56 match the win numbers, credit points as many as 100 times of the chips bet in the number-of-chips display section 57 is paid out and is added to the current credit points owned by the player. When one of the three numbers selected by the player in the selected number display section 56 matches one of the win numbers, credit points as many as three times of the chips bet in the number-of-chips display section 57 is paid out and is added to the current credit points owned by the player. When none of the three numbers selected by the player in the selected number display section 56 match the win numbers, no award of additional credit points is paid out to the player.

Subsequently, the number selection section 44 will be discussed. The number selection section 44 includes 38 numeric buttons 63 of numbers “0,” “00,” and “1” to “36” displayed on the number indication plates 14 of the roulette wheel 3, and a cancel button 64 displayed as “Select Cancel.” The player places a cursor 55 on each of the selected number display sections 50A to 50C of the bet display section 52 and subsequently presses any numeric button 63 to select the number corresponding to the pressed numeric button 63. The player places the cursor 55 on the already selected number and subsequently presses the cancel button 64 to cancel the already selected number. Again, “?” mark is displayed in the selected number display sections 50A to 50C where the number is canceled.

The result number display section 54 displays the lottery results with the roulette wheel 3 in the past three games and includes a first result number display section 54A displaying the win number of the lottery result with the roulette wheel 3 in the immediately preceding game, a second result number display section 54B displaying the win number of the lottery result with the roulette wheel 3 in the game before the preceding game, and a third result number display section 54C displaying the win number of the lottery result with the roulette wheel 3 in the two games before the preceding game. The player references the win numbers displayed in the result number display section 54, whereby it is made possible for the player to easily determine whether or not the numbers displayed in the selected number display section 56 of the bet result display section 53 match the win numbers.

The result history display section 45 lists the results of the win numbers in the previous games (one game refers to an operation sequence from the player betting a chip in a usual roulette game using the first BET screen to the ball 16 dropping to the ball housing groove 13 to paying out credit based on the win number). When one game is over, a new win number is added to the top of the result history display section 35 for display and the player can check the history of the win numbers of a maximum of 16 games.

The screen switch button 46 is a button that allows the player to switch between the first BET screen 31 and the second BET screen 33 displayed on the image display 7 as mentioned above. Two character strings of “Roulette” and “Loto3” are displayed on the screen switch button 34. When the player presses the screen switch button 46 on the liquid crystal screen 29, the second BET screen 33 using the number selection betting board 32 is switched to the first BET screen 31 using the table betting board 30 for display. The player bets a chip based on the betting board on the current displayed screen.

The betting unit selection buttons 47 are buttons each for betting a predetermined number of chips by units, such as by five chips or by ten chips, on the number-of-chips display section 51 specified by the player. The following four types of betting unit selection buttons 47 are included: 1-BET button 47A, 5-BET button 47B, 10-BET button 47C, and 100-BET button 47D.

The player first selects three numbers in the selected number display section 50 and then specifies the bet display section 52 to bet by pressing the number-of-chips display section 51 to the side of the selected number display section 50. The cursor 55 is placed on the specified number-of-chips display section 51. In this state, when the player presses the 1-BET button 47A, one chip is bet at a time (the number of bet chips increases such as “1”->“2”->“3” and so on each time the player presses the 1-BET button 47A with a finger). When the player presses the 5-BET button 47B, five chips are bet at a time (the number of bet chips increases such as “5”->“10”->“15” and so on each time the player presses the 5-BET button 47B with a finger). When the player presses the 10-BET button 47C, 10 chips are bet at a time (the number of bet chips increases such as “10”->“20”->“30” and so on each time the player presses the 10-BET button 47C with a finger). When the player presses the 100-BET button 47C, 100 chips are bet at a time (the number of bet chips increases such as “100”->“200”->“300” and so on each time the player presses the 100-BET button 47D with a finger).

According to the above configuration, the betting operation is simplified when betting a large number of chips.

The payback result display section 48 displays the number of bet chips of the player in the preceding game and the paid-back credit points. Here, subtracting the number of bet chips from the paid-back credit points results in the credit points newly gained by the player playing the preceding game.

The credit points display section 49 displays the credit points presently owned by the player. When the player bets chips, the credit points is decremented by the number of the chips bet (one credit points per chip). If the number in the bet display section 52 to bet matches the win number and the credit based on the award table 61 is paid back, the credit points is incremented by the paid-back credit points. If the credit points owned by the player reaches 0, the game is over.

A BET timer graph 65 is provided at a topmost position of the number selection betting board 32 of the second BET screen 33 as with the first BET screen 31 described above. The BET timer graph 65 is a graph for indicating the remaining time during which the player can bet, and a red graph extends gradually to the right with the passage of time from the game start time. When the graph extends to the rightmost side, the time during which the player can bet in the current game expires. When the bet period of the player at each satellite 4 expires, namely, when the BET timer graph 65 reaches the rightmost side, the ball discharging unit discharges the ball 16 into the roulette wheel 3.

The cursor 55 indicating the selected number display section 50 and the number-of-chips display section 51 is displayed on the number selection betting board 32. A chip mark 41 indicating the number of bet chips and the bet display section 52 so far is also displayed on the number selection betting board 32. The number displayed on the chip mark 41 denotes the number of chips bet. For example, the chip mark 41 displayed with “10” placed on the bet display section 52 where “12,” “21,” and “30” are selected as shown in FIG. 4 indicates that the player bets 10 chips on the three numbers “12,” “21,” and “30”.

To bet a chip on the second BET screen 33 described above, first the player specifies any of the selected number display sections 50A to 50C where “?” mark is displayed, of the bet display section 52 on the screen and presses the selected number display section 50 directly with a finger. Consequently, the cursor 55 moves to the specified one of the selected number display sections 50A to 50C.

Then, the player presses the numeric button 63 on which any desired number is displayed in the number selection section 44, thereby specifying the number. After specifying the numbers in all the three selected number display sections 50A to 50C, the player presses the number-of-chips display section 51 provided to the side of the selected number display sections 50A to 50C. Subsequently, whenever the player presses one of the betting unit selection buttons 47 (1-BET button 47A, 5-BET button 47B, 10-BET button 47C, 100-BET button 47D), as many chips as the number indicated by the betting unit selection button are bet on the number-of-chips display section 51 of the bet display section 52 specified. For example, when the player presses the 10-BET button 47C four times, the 5-BET button 47B once, and the 1-BET button 47A three times, a total of 48 chips are bet.

As described above, the player presses the screen switch button 34, 46 for switching between the first BET screen 31 provided with the usual table betting board 30 and the second BET screen 33 provided with the new number selection betting board 32 for display.

In a roulette game using the second BET screen 33, the player predicts the lottery results with the roulette wheel 3 in the three lotteries including the current lottery and select three numbers at a time from among the numbers displayed on the number indication plates 14 of the roulette wheel 3 (38 numbers of “0,” “00,” and “1” to “36”) using the number selection section 44 and can receive payout of credit points based on the number of the selected numbers matching the win numbers from the three lottery results, so that the player can play a new Loto-type roulette game in addition to a usual roulette game in one roulette gaming machine 1 and the variety of game plays can be increased. In the Loto-type game with the second BET screen 33, the credit points payout is determined based on the three lottery results including the current lottery with the roulette wheel 3, so that the player can play a game with a sense of anticipation over a long time and can continue to have interest in the game.

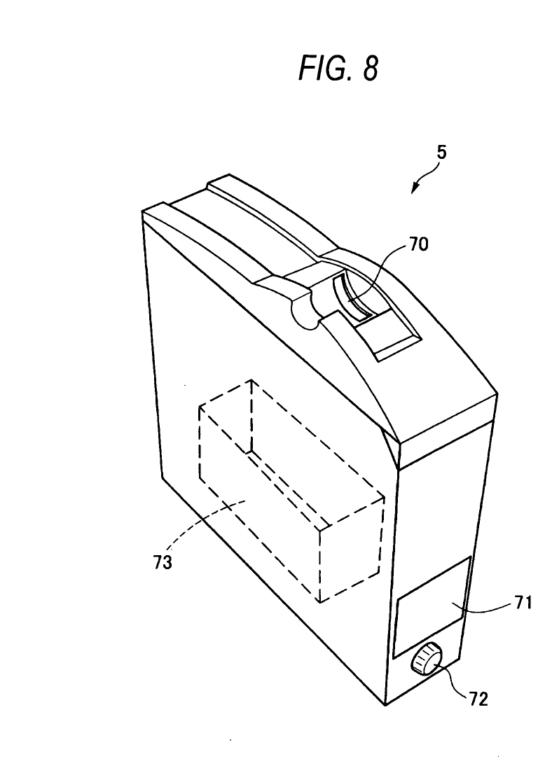

Next, the configuration of the medal acceptance unit 5 according to the first embodiment will be discussed with FIG. 8. FIG. 8 is a perspective view to show the medal acceptance unit according to the first embodiment.

As shown in FIG. 8, the medal acceptance unit 5 is a unit substantially shaped like a rectangular parallelepiped for inputting game media such as coins and medals, and accepting the game media. The credit points responsive to the accepted game media is added to the credit points owned by the player and the update is displayed in the credit points display section 38, 49.

The medal acceptance unit 5 is provided with a medal insertion slot 70 for inputting a game media such as coins and medals, a medal return opening 71 for returning input medals to the player, and a key insertion slot 72 used to open and close the inside of the medal acceptance unit 5.

The key insertion slot 72 is an insertion slot of a key (not shown) for opening and closing a door (not shown) provided on the medal acceptance unit 5. When a predetermined key is inserted and is turned in a predetermined direction, the lock state of a locking unit is released and the door is opened. A medal storage section 73 for storing input medals is installed in the medal acceptance unit 5. As the door is opened, the medals in the medal storage section 73 can be collected. Further, it is also made possible to conduct internal maintenance.

Next, the configuration of a control system of the roulette gaming machine 1 will be discussed based on FIG. 9. FIG. 9 is a block diagram to schematically show the control system of the roulette gaming machine.

As shown in FIG. 9, the roulette gaming machine 1 is including a main control section 83 including a main control CPU 80, ROM 81, and RAM 82 and the roulette wheel 3 and the 10 satellites 4 connected to the main control section 83 (see FIG. 1). The control system of the satellite 4 is described later in detail.

The main control CPU 80 performs various types of processing based on input signals supplied from the satellites 4 and data and programs stored in the ROM 81 and the RAM 82, and transmits instruction signals to the satellites 4 based on the processing result, thereby controlling the satellites 4 under the initiative of the main control CPU 80 for advancing games. Further, the main control CPU 80 controls a win determination unit 84, a ball discharging unit 85, and a ball collection unit 86 installed in the roulette wheel 3 for inputting the ball 16 into the roulette wheel 3, collecting the ball 16 from the roulette wheel 3, and determining the win number corresponding to the ball housing groove 13 into which the ball 16 drops. The main control CPU 80 makes a win or loss determination of bet chips based on the obtained win number and bet information transmitted from each satellite 4 and calculates the credit points to be paid out to the player at the satellite 4.

The ROM 81 is implemented as semiconductor memory for example, and stores a program for providing the basic function of the roulette gaming machine 1, a program for controlling the units in the roulette wheel 3, the odds for a usual roulette game using the first BET screen 31 (the credit payout number of chips responsive to a win per chip), the award table 61 for the number of identical number pairs in a Loto-type roulette game using the second BET screen 33 (see FIG. 7), a program for controlling the satellites 4 under the initiative of the main control CPU 80, and the like.

On the other hand, the RAM 82 temporarily stores chip bet information supplied from the satellites 4, the win number of the roulette wheel 3 determined by the win determination unit 84, data concerning the result of the processing executed by the main control CPU 80.

The win determination unit 84, the ball discharging unit 85, and the ball collection unit 86 installed in the roulette wheel 3 are also connected to the main control CPU 80. When the bet time of the player at each satellite 4 expires, namely, when the BET timer graph 39, 65 of the first BET screen 31, the second BET screen 33 reaches the rightmost side, the ball discharging unit 85 discharges the ball 16 into the roulette wheel 3.

Further, when the rotation speed of the ball 16 gradually reduces and the ball 16 loses the centrifugal force, rolls down the slope of the frame 11, and is housed in any one of the ball housing grooves 13, the win determination unit 84 determines the number described on the number indication plate 14 corresponding to the ball housing groove 13 in which the ball 16 is housed, and transmits the determination result to the main control CPU 80. Then, the ball collection unit 86 is driven for collecting the ball 16 from the top of the roulette wheel 3.

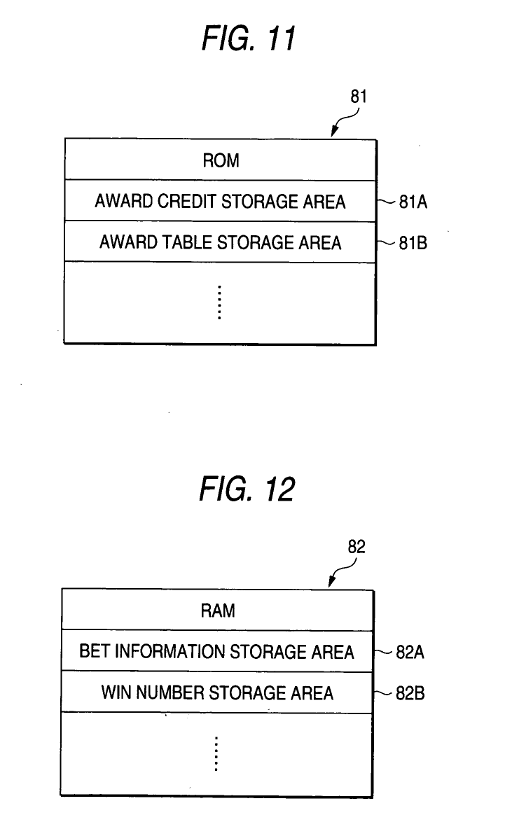

As shown in FIG. 11, the ROM 81 is provided with an award credit storage area 81A storing the odds concerning a usual roulette game using the first BET screen 31 and an award table storage area 81B storing the award table 61 storing the odds concerning a Loto-type roulette game using the second BET screen 33 (see FIG. 7). As the odds for each BET area 42 of the first BET screen 31 stored in the award credit storage area 81A, an award of “X2” to “X36” is given depending on the bet method (straight up, corner bet, split bet, etc.,). On the other hand, as the odds in the award table 61 stored in the award table storage area 81B, an award of “X3” to “X1000” is given depending on the number of identical number pairs as described above.

The RAM 82 is provided with a bet information storage area 82A for storing the bet information of the player playing a game at present and a win number storage area 82B for storing the win number of the roulette wheel 3 determined by the win determination unit 84. The bet information specifically includes the BET areas 42 and the number of bet chips specified on the first BET screen 31 and the three numbers and the number of bet chips specified on the second BET screen 32.

Next, the configuration of the control system of the satellite 4 connected to the CPU 80 of the main control section 83 will be discussed based on FIG. 10. FIG. 10 is a block diagram to schematically show the control system of the satellite 4 according to the first embodiment. The 10 satellites 4 basically have the same configuration and therefore in the description to follow, one satellite 4 is taken as an example.

As shown in FIG. 10, the satellite 4 is basically including a main body 89 in which the image display 7 and the like are installed and the medal acceptance unit 5 attached to the main body 89. Further, the main body 89 is including a satellite control section 90 and several peripheral machines. The satellite control section 90 is including a satellite control CPU 91, ROM 92, and RAM 93. The ROM 92 is implemented as semiconductor memory, for example, and stores a program for providing the basic function of the satellite 4, various programs required for controlling the satellite 4, a data table, and the like. The RAM 93 is memory for temporarily storing various pieces of data on which operations are performed by the satellite control CPU 91, the current credit points owned by the player, the chip bet state of the player, and the like.

The BET confirmation button 22, the payback button 23, and the help button 24 placed on the control section 6 (see FIG. 1) are connected to the satellite control CPU 91. Based on an operation signal output as each button is pressed, etc., the satellite control CPU 91 controls the satellite to execute the corresponding operation. Specifically, the satellite control CPU 91 executes processing based on an input signal supplied from the control section 6 in response to entry of operation of the player and the data and the programs stored in the ROM 92 and the RAM 93, and transmits the processing result to the main control CPU 80 of the main control section 83 described above.

On the other hand, the satellite control CPU 91 receives an instruction signal from the main control CPU 80 and controls the peripheral machines making up the satellite 4 for advancing the roulette game in the satellite 4. Alternatively, the satellite control CPU 91 executes processing based on an input signal supplied from the control section 6 in response to entry of operation of the player and the data and the programs stored in the ROM 92 and the RAM 93, and controls the peripheral machines making up the satellite 4 for advancing the roulette game in the satellite 4. Which method the processing is to be performed according to is determined for each processing in response to the processing type. For example, medal payout processing responsive to the win number corresponds to the former type of processing and bet operation processing of the player on the first BET screen 31 or the second BET screen 33 corresponds to the latter type of processing.

A hopper 94 is also connected to the satellite control CPU 91. The hopper 94 pays out a predetermined number of medals to the player from the medal payout opening 8 (see FIG. 1) in response to an instruction signal from the satellite control CPU 91.

The image display 7 is connected via a liquid crystal drive circuit 95 to the satellite control CPU 91. The liquid crystal drive circuit 95 includes program ROM, image ROM, an image control CPU, work RAM, a VDP (video display processor), and video RAM. The program ROM stores an image control program and various selection tables concerning display on the image display 7. The image ROM stores dot data to form images displayed on the image display 7. The image control CPU determines the image to be displayed on the image display 7 from the dot data previously stored in the image ROM in accordance with the image control program previously stored in the program ROM based on a parameter set in the satellite control CPU 91. The work RAM is implemented as temporary storage for the image control CPU to execute the image control program. The VDP forms an image responsive to the display determined by the image control CPU and outputs the image to the image display 7. The video RAM is implemented as temporary storage for the VDP to form an image.

The touch panel 28 is attached to the front of the image display 7 as mentioned above, and operation information of the touch panel 28 is transmitted to the satellite control CPU 91. Through the touch panel 28, the player bets chips on the first BET screen 31 or the second BET screen 33. Specifically, the player operates the touch panel 28 in selecting the BET area 42, operating the screen switch button 34, 46, the betting unit selection button 36, 47, moving the cursor 55 to the selected number display sections 50A to SOC, the number-of-chips display section 57, pressing the numeric button 63, and the like, and touch panel operation information is transmitted to the satellite control CPU 91. Based on the information, the bet information of the current player (the BET areas 42 and the number of bet chips specified on the first BET screen 31 and the three numbers and the number of bet chips specified on the second BET screen 32) is stored in the RAM 93 whenever necessary. The bet information is transmitted to the main control CPU 80 and is stored in the bet information storage area 82A of the RAM 82.

Further, a sound output circuit 96 and the above-mentioned speaker 9 are connected to the satellite control CPU 91. The speaker 9 generates various effect sounds in making various effects based on output signals from the sound output circuit 96.

A data reception section 97 is also connected to the satellite control CPU 91 and further the medal acceptance unit 5 is connected to the data reception section 97. The medal acceptance unit 5 is a unit into which the player inputs game media of coins and medals, in playing a game, as mentioned above.

The data reception section 97 receives a credit signal transmitted from the medal acceptance unit 5. The credit signal is information concerning the added credit points based on the game media of coins, medals, etc., input into the medal acceptance unit 5. The satellite control CPU 91 increments the credit points of the player stored in the RAM 93 based on the received credit signal.

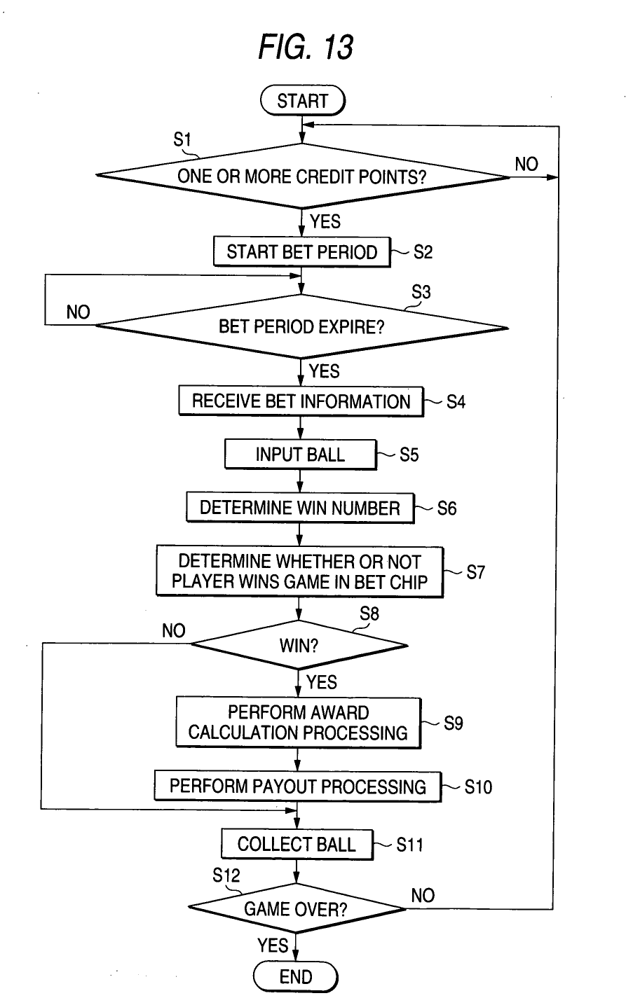

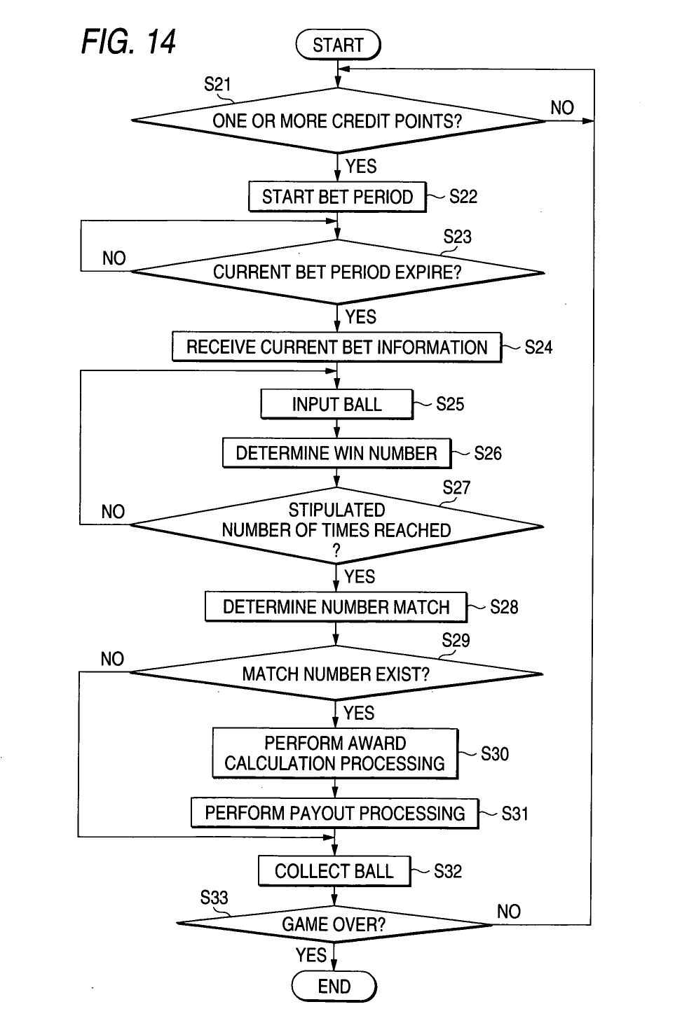

Subsequently, main processing programs in the roulette gaming machine 1 will be discussed based on FIGS. 13 and 14. First, a game processing program for a usual roulette game using the first BET screen 31 will be discussed. FIG. 13 is a flowchart of the game processing program for a usual roulette game using the first BET screen 31. The program shown in the flowchart of FIG. 13 is stored in the ROM 81 and the RAM 82 included in the roulette gaming machine 1 and is executed by the main control CPU 80.

First, at step 1 (S1), the main control CPU 80 determines whether or not the player owns one or more credit points. In the roulette gaming machine 1 according to the first embodiment, when a medal or a coin is input into the medal acceptance unit 5 at any of the satellites 4, a medal input signal is sent from the satellite control section 90 of the satellite 4 to the main control section 83. According to the signal, the main control CPU 80 determines the input of the medal or the coin and increments the credit points owned by the player. The credit points incremented by the CPU 80 according to the number of input medals or coins, is recorded by the satellite control section 90 in the RAM 93 as the credit data indicative of the credit points. If no credit points is owned by the player (NO at S1), a wait mode is entered until the medal or the coin is input; if one or more credit points are owned by the player (YES at S1), the process proceeds to S2.

The first BET screen 31 shown in FIG. 3 is displayed on the image display 7 of the satellite 4 used by the player, enabling the player to bet a chip. Other players can enter the game at midpoint and the roulette gaming machine 1 according to the first embodiment allows a maximum of 10 players to play a game.

When the first player entering the game inputs a medal or a coin, the bet period in which each player can bet chip is started (S2). If the current game follows the preceding game, the bet period is started immediately after the preceding game is over. Each player entering the game can operate the touch panel 28 during the bet period to bet his or her chip on the BET area 42 corresponding to his or her predicted number (see FIG. 3). The specific bet method using the first BET screen 31 is already described and therefore will not be discussed again.

Next, whether or not the bet period expires is determined at S3. The bet period is displayed with the BET timer graph 39. When the bet period starts (S2), the red graph starts to extend to the right gradually. When the red graph extends to the rightmost side, the bet period in the current game expires.

Before the bet period expires (NO at S3), bet is accepted. If the bet period expires (YES at S3), a bet end signal is output to the satellite control sections 90 of all satellites 4 and an image to the effect that the bet period expires is displayed on the liquid crystal screen 29 of each satellite 4, disabling each player from performing bet operation on the touch panel 28. The bet information of the player at each satellite 4 (specified BET area 42 and the number of bet chips on the specified BET area 42) is received (S4) and is stored in the bet information storage area 82A of the RAM 82.

Next, the main control CPU 80 executes lottery processing with the roulette wheel 3 in accordance with a game execution program. First, at S5, the ball discharging unit 85 discharges the ball 16 into the roulette wheel 3. The discharged ball 16 rolls on the roulette wheel 3 along the guide wall 18. Then, when the rotation speed reduces and the centrifugal force is lost, the ball 16 rolls down the slope of the frame 11 and goes to the inside thereof and arrives at the rotating rotation disk 12 (see FIG. 2).

The ball 16 rolling to the rotation disk 12 is housed in any one of the ball housing groove 13 through the tops of the number indication plates 14 outside the rotating rotation disk 12, and the number described on the number indication plate 14 corresponding to the ball housing groove 13 in which the ball 16 is housed (any one of “0,” “00,” “1” to “36”) becomes the win number.

Subsequently, after the ball 16 is housed in the ball housing groove 13, the main control CPU 80 drives the win determination unit 84 for determining which number the ball is housed in the ball housing groove 13 corresponding thereto (S6)

Further, the main control CPU 80 determines whether or not the player at each satellite 4 wins the game in the bet chip from the bet information at each satellite 4 received at S4 and the win number determined at S6 (S7).

Whether or not the player at at least one satellite 4 wins the game in the bet chip is determined based on the win or loss determination at S7 (S8) If it is determined that the player at at least one satellite 4 wins the game in the bet chip (YES at S8), the main control CPU 80 executes award calculation processing (S9). In the award calculation processing, the win chip is recognized for each satellite 4 and the total award amount of credit paid out to the player at each satellite 4 is calculated using the odds for each BET area 42 stored in the award credit storage area 81A of the ROM 81 (the credit points paid out per chip). Subsequently, the process proceeds to S10.

On the other hand, if it is determined that none of the players at the satellites 4 win the game in the bet chip (NO at S8), the process proceeds to S11.

At S10, credit payout processing is executed based on the award calculation processing at S9. To pay out credit to the player at the satellite 4, the main control section 83 outputs the credit data corresponding to the award amount to the satellite control section 90 of the satellite 4 of the winning player. The credit data is added to the RAM 93 of the satellite 4 of the winning player.

At S11, the ball collection unit 86 installed below the rotation disk 12 is driven for collecting the ball 16 on the rotation disk 12. The collected ball 16 will again be discharged to the roulette wheel 3 in the later game. Following S1, the process proceeds to S12.

At S12, whether or not the player at at least one satellite 4 continues to play a game is determined. To quit playing another game, usually the player presses the payback button 23. If the payback button 23 is pressed, as many medals as the number responsive to the credit points owned by the player at present gained by playing the game, (usually, one medal per credit points) are paid back to the player from the medal payout opening 8.

If the player at any satellite 4 continues to play a game (NO at S12), the process returns to S1 and another bet period is started for starting another game.

On the other hand, if the players at all satellites 4 quit playing a game (YES at S12), the roulette game processing is terminated.

Next, a game processing program for a Loto-type roulette game using the second BET screen 33 will be discussed. FIG. 14 is a flowchart of the game processing program for a Loto-type roulette game using the second BET screen 33. The program shown in the flowchart of FIG. 14 is stored in the ROM 81 and the RAM 82 included in the roulette gaming machine 1 and is executed by the main control CPU 80.

First, at S21, the main control CPU 80 determines whether or not the player owns one or more credit points. In the roulette gaming machine 1 according to the first embodiment, when a medal or a coin is input into the medal acceptance unit 5 at any of the satellites 4, a medal input signal is sent from the satellite control section 90 of the satellite 4 to the main control section 83. According to the signal, the main control CPU 80 determines the input of the medal or the coin and increments the credit points owned by the player. The credit points incremented by the CPU 80 according to the number of input medals or coins, is recorded by the satellite control section 90 in the RAM 93 as the credit data indicative of the credit points. If no credit points is owned by the player (NO at S21), a wait mode is entered until the medal or the coin is input; if one or more credit points are owned by the player (YES at S21), the process proceeds to S22.

The second BET screen 33 shown in FIG. 4 is displayed on the image display 7 of the satellite 4 used by the player, enabling the player to bet a chip. Other players can enter the game at midpoint and the roulette gaming machine 1 according to the first embodiment allows a maximum of 10 players to play the game.

When the first player entering the game inputs a medal or a coin, or when one or more players owns one or more credit points, the bet period in which each player can bet chip is started (S22). Unlike the usual roulette game, the Loto-type roulette game allows the player to bet a chip in the next game immediately after the predetermined bet period expires.

Each player entering the game can operate the touch panel 28 during the bet period to select three numbers (for example, “17,” “2,” and “00”) and bet his or her chip (see FIG. 4). The specific bet method using the second BET screen 33 is already described and therefore will not be discussed again.

Next, whether or not the current bet period expires is determined at S23. The current bet period is displayed with the BET timer graph 65. When the bet period in the preceding game expires, the red graph starts to extend to the right gradually. When the red graph extends to the rightmost side, the bet period in the current game expires.

Before the bet period expires (NO at S23), bet is accepted. If the bet period expires (YES at S23), a bet end signal is output to the satellite control sections 90 of all satellites 4 and an image to the effect that the current bet period expires is displayed on the liquid crystal screen 29 of each satellite 4. After this, the player is allowed to only perform bet operation in the next game. The current bet information of the player at each satellite 4 (specified three numbers and the number of bet chips on the three specified numbers) is received (S24) and is stored in the bet information storage area 82A of the RAM 82.

Next, the main control CPU 80 executes lottery processing with the roulette wheel 3 in accordance with a game execution program. First, at S25, the ball discharging unit 85 discharges the ball 16 into the roulette wheel 3. The discharged ball 16 rolls on the roulette wheel 3 along the guide wall 18. Then, when the rotation speed reduces and the centrifugal force is lost, the ball 16 rolls down the slope of the frame 11 and goes to the inside thereof and arrives at the rotating rotation disk 12 (see FIG. 2).

The ball 16 rolling to the rotation disk 12 is housed in any one of the ball housing groove 13 through the tops of the number indication plates 14 outside the rotating rotation disk 12, and the number described on the number indication plate 14 corresponding to the ball housing groove 13 in which the ball 16 is housed (any of “0,” “00,” “1” to “36”) becomes the win number.

Subsequently, after the ball 16 is housed in the ball housing groove 13, the main control CPU 80 drives the win determination unit 84 for determining which number the ball is housed in the ball housing groove 13 corresponding to (S26).

Then, at S27, whether or not lottery processing has been performed a stipulated number of times is determined. In the first embodiment, three lotteries are drawn with the roulette wheel 3 for one game and three win numbers (for example, 2, 1, and 0) are determined.

If lottery processing has not yet been performed the stipulated number of times (NO at S27), the process returns to S25 and the ball 16 is discharged and the next lottery is made.

On the other hand, if lottery processing has been performed the stipulated number of times (YES at S27), the process proceeds to S28.

At S28, how many of the three numbers selected at each satellite 4 (for example, “17,” “2,” and “00”) match the three win numbers (for example, “2,” “1,” and “0”) is determined from the bet information at the satellite 4 received at S24 and the three win numbers determined at S26. Then, the process proceeds to S29.

Whether or not the match number exists at at least one satellite 4 is determined based on the number match determination at S28 (S29). If it is determined that the match number exists (YES at S29), the main control CPU 80 executes award calculation processing (S30). In the award calculation processing, the win chip is recognized for each satellite 4 and the total award amount of credit paid out to the player at each satellite 4 is calculated using the award table 61 stored in the award table storage area 81B of the ROM 81. Subsequently, the process proceeds to S31.

On the other hand, if it is determined that the match number does not exist at any satellites 4 (NO at S29), the process proceeds to S32.

At S31, credit payout processing is executed based on the award calculation processing at S30. To pay out credit to the player at the satellite 4, the main control section 83 outputs the credit data corresponding to the award amount to the satellite control section 90 of the satellite 4 of the winning player. The credit data is added to the RAM 93 of the satellite 4 of the winning player.

At S32, the ball collection unit 86 installed below the rotation disk 12 is driven for collecting the ball 16 on the rotation disk 12. The collected ball 16 will again be discharged to the roulette wheel 3 in the later game. Following S11, the process proceeds to S33.

At S33, whether or not the player at at least one satellite 4 continues to play a game is determined. To quit playing another game, usually the player presses the payback button 23. If the payback button 23 is pressed, as many medals as the number responsive to the credit points presently owned by the player (usually, one medal per credit points) are paid back to the player from the medal payout opening 8.

If the player at any satellite 4 continues to play a game (NO at S33), the process returns to S21 and the player is again allowed to bet for another game.

On the other hand, if the players at all satellites 4 quit playing a game (YES at S33), the Loto-type roulette game processing is terminated.

The usual roulette game played at S1 to S12 and the Loto-type roulette game played at S21 to S33 are advanced on one roulette gaming machine 1 at the same time. That is, the player can switch the display screen between the first BET screen 31 and the second BET screen 33 by pressing the screen switch button 34, 46 displayed on the liquid crystal screen 29 and can play a Loto-type roulette game by displaying the second BET screen 33 while playing a usual roulette game using the first BET screen 31.

As described above, the roulette gaming machine 1 according to the first embodiment enables the player to switch the display screen between the first BET screen 31 provided with the table betting board 30 like a usual betting table and the second BET screen 33 provided with the new number selection betting board 32 by pressing the screen switch button 34, 46.

In the roulette game using the second BET screen 33, the player can predict the lottery results in the three lotteries including the current lottery and select three numbers at a time from among the numbers displayed on the number indication plates 14 of the roulette wheel 3 (38 numbers of “0,” “00,” and “1” to “36”) using the number selection section 44. Then, after lottery processing is performed three times with the roulette wheel 3, how many of the three selected numbers match the win numbers is determined, and credit is paid out based on the match number count (the number of identical number pairs), so that the player can play the new Loto-type roulette game on one roulette gaming machine 1. Therefore, the variety of game plays of the roulette gaming machine 1 can be increased and the player can continue to have interest in the game.

Further, in the Loto-type roulette game using the second BET screen 33, credit award at a high ratio of 1000 times at the maximum is given to the player, so that the desire of the player to play a game can be increased.

The player can also bet a chip on the second BET screen 33 during the number lottery with the roulette wheel 3 after the bet period expires, so that the game play efficiency is enhanced.

Further, the player can also play a usual roulette game of predicting only the current win number on the first BET screen 31 using the table betting board 30 displayed by pressing the screen switch button 46, so that bet considering various demands of the player is made possible.

The invention is not limited to the specific embodiment described above and various improvements and modifications can be made without departing from the spirit and the scope of the invention.

For example, in the first embodiment, as for the bet method on the second BET screen 33, the player predicts the lottery results in the three lotteries including the current lottery and selects three numbers at a time through the number selection section 44, but the number of selected numbers is not limited to three and may be two or more. At the time, as the number of selected numbers increases, the ratio of award to be paid out to the winning player can be made larger.

In the first embodiment, as for the Loto-type roulette game using the second BET screen 33, the award ratio of payout of credit responsive to the number of identical number pairs is fixed according to the award table 61, but may be changed at random from one game to another.

In the first embodiment, screen display is switched between the first BET screen 31 and the second BET screen 33 as the player presses the screen switch button 34, 46, but the liquid crystal screen 29 may be divided into two parts of left and right parts or upper and lower parts for displaying the first BET screen 31 and the second BET screen 33 at the same time. This enables the player to play two types of games at the same time without the need for operating the screen switch button 34, 46 for switching the screen.

In the first embodiment, CPU 80 serves as a first game processing unit that provides a first game (a roulette game) and as a second game processing unit that provides a second game (a Loto-type game) different from the first game.

### Second Embodiment

Hereinafter, a roulette gaming machine 100 according to a second embodiment will be described with reference to the drawings.

In the first embodiment described above, the roulette gaming machine 1 is configured to provide to the player two types of games of a roulette game (a first game) using the first BET screen 31 and a Loto-type game (a second game) using the second BET screen 33. In contrast, the roulette gaming machine 100 according to the second embodiment is configured to provide to the player two types of games of the roulette game (a first game) and a Numbers-type game (a second game).

In the following description and drawings for the second embodiment, parts the same as those in the first embodiment are denoted by the same reference numerals as those in the first embodiment, and detailed description of the parts and configurations the same as those in the first embodiment will be omitted.

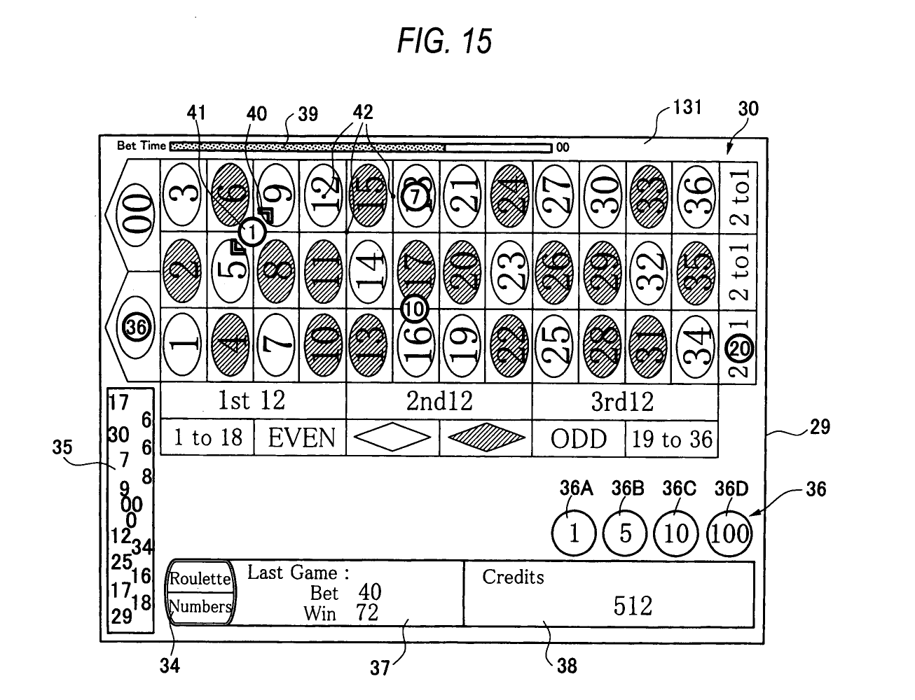

In the second embodiment, the roulette gaming machine 100 provides the roulette game to the player in substantially the same manner with the first embodiment. The roulette game is played by the player through a first BET screen 31 as shown in FIG. 15. The first BET screen 131 has substantially the same appearance as the first BET screen 31 in the first embodiment, which is shown in FIG. 3.

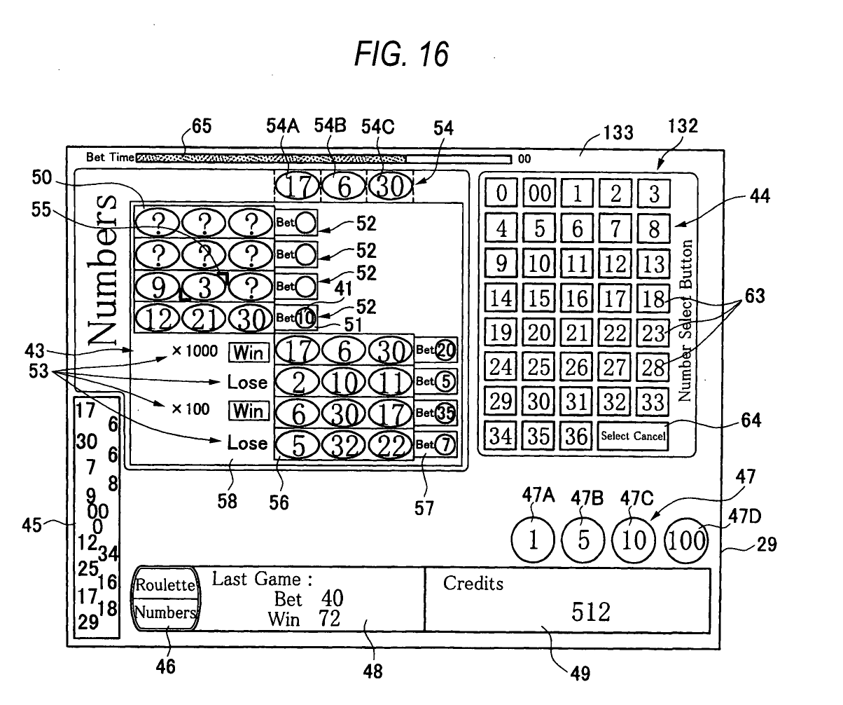

The roulette gaming machine 100 provides the Numbers-type game to the player through a second BET screen 133 as shown in FIG. 16.

As shown in FIGS. 15 and 16, during the gaming with the roulette gaming machine 100, the image display 7 displays two types of screens of the first BET screen 131 having the usual table betting board 30 for predicting the win number only in the current game and the second BET screen 133 having a Numbers-type number selection betting board 132 for predicting the composite win number of three to six digits formed by a total of three win numbers on the roulette wheel 3. The display can be switched between the first BET screen 131 and the second BET screen 133 each time a screen switch button 34, 46 displayed on the liquid crystal screen 29 is pressed. After selecting either of the first BET screen 131 and the second BET screen 133, the player bets chips using the credit points owned by the player.

The screen switch button 34 is a button for switching between the first BET screen 131 and the second BET screen 133 displayed on the image display 7 as mentioned above. Two character strings of “Roulette” and “Numbers” are displayed on the screen switch button 34. If the player presses the screen switch button 34 on the liquid crystal screen 29, the first BET screen 131 using the table betting board 30 can be switched to the second BET screen 133 using the number selection betting board 132 for display. Then, the player bets a chip based on the betting board on the current displayed screen.

Next, the second BET screen 133 will be discussed based on FIG. 16. With the second BET screen 133, the player uses the number selection betting board 132 to play a Numbers-type roulette game for predicting the win numbers formed by a plurality of digits (three to six digits) of the winning numbers in a total of three lotteries including the current lottery at a time.

The number selection betting board 132 displayed on the second BET screen 133 basically includes the selection result display section 43 for displaying the selected numbers, and the number selection section 44 pressed by the player for selecting a number. Displayed at a lower portion of the number selection betting board 132 are the result history display section 45, the above-mentioned screen switch button 46, the betting unit selection buttons 47, the payback result display section 48, and the credit points display section 49 as with the first BET screen 131 described above.

The screen switch button 46 is a button for switching between the first BET screen 131 and the second BET screen 133 displayed on the image display 7 as mentioned above. Two character strings of “Roulette” and “Numbers” are displayed on the screen switch button 46. If the player presses the screen switch button 46 on the liquid crystal screen 29, the second BET screen 133 using the number selection betting board 132 can be switched to the first BET screen 131 using the table betting board 30 for display. Then, the player bets a chip based on the betting board on the current displayed screen.

The cursor 55 indicating the lottery number display section 50 selected by the player at present and the number-of-chips display section 51 is displayed on the number selection betting board 132. A chip mark 41 indicating the number of bet chips and the bet display section 52 so far is also displayed on the number selection betting board 132. The number displayed on the chip mark 41 denotes the number of bet chips. For example, the chip mark 41 displayed with number “10” placed on the bet display section 52 where “12,” “21,” and “30” are selected as shown in FIG. 16 indicates that 10 chips are bet on the six-digit lottery number “122130.”

The selection result display section 43 displays the lottery number of a plurality of digits selected by the player through the number selection section 44, the number of bet chips, and the lottery result. Specifically, the selection result display section 43 includes a plurality of substantially rectangular bet display sections 52 each including a lottery number display section 50 for displaying the lottery number of a plurality of digits (three to six digits) formed by the three numbers selected by the player and a number-of-chips display section 51 for displaying the number of bet chips and a plurality of bet result display sections 53 for indicating information concerning the previous bets of the player with the win or loss result confirmed in the preceding game in the same format as the bet display sections 52, as shown in FIG. 16.

A result number display section 54 indicating the three win numbers determined by the roulette wheel 3 in the past lotteries is provided above the bet display sections 52. In the Numbers-type roulette game according to the second embodiment, the composite win number is determined by the past three win numbers. The composite win number is the number of three to six digits provided by combining the win numbers starting at the new win number at the left. Since the result number display section 54 describes the number starting at the new lottery result with the roulette wheel 3 at the left as described later, the formed composite win number is specifically displayed on the result number display section 54. For example, if the win number in the immediately preceding is “17,” and the win number in the game before the preceding game is “6,” and the win number in the two games before the preceding game is “30” as shown on the result number display section 54 in FIG. 16, the composite win number becomes “17630.”

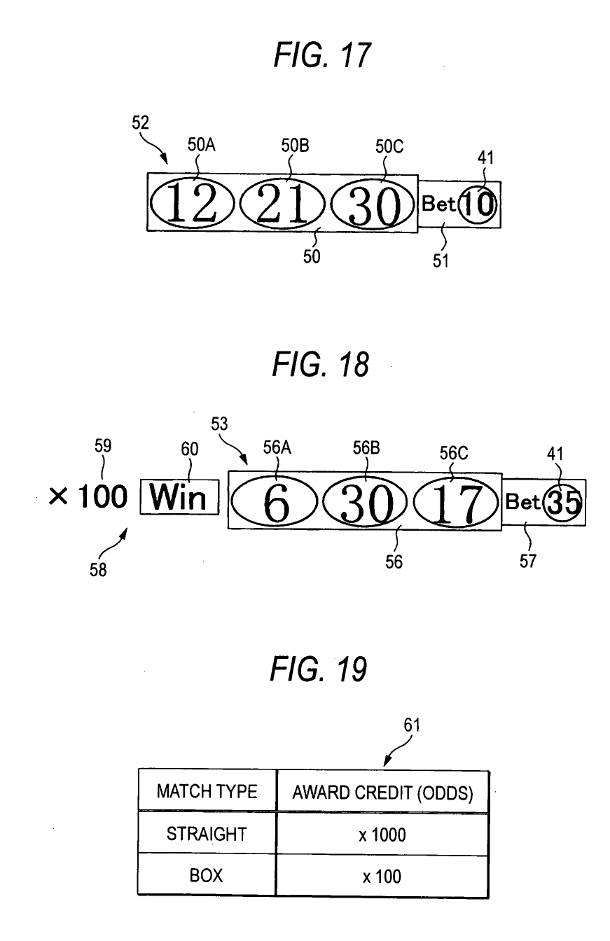

First, the bet display sections 52 will be discussed. FIG. 17 is a schematic drawing to show the bet display section 52 of the second BET screen 133 according to the second embodiment.

The lottery number display section 50 of the bet display section 52 is provided with three display sections of a first selected number display section 50A, a second selected number display section SOB, and a third selected number display section 50C from the left to the right facing the liquid crystal screen 29. The three numbers selected by the player using the number selection section 44 are displayed on the selected number display sections 50A to 50C, forming the lottery number of three to six digits. (For example, if the player selects “12” in the first selected number display section 50A, “21” in the second selected number display section SOB, and “30” in the third selected number display section 50C, the lottery number becomes “122130.”)

Before numbers are selected, “?” marks are displayed on the selected number display sections 50A to 50C as shown in FIG. 16. The player selects any of the selected number display sections 50A to 50C using a cursor described below and selects any numbers through the number selection section 44, whereby the player-selected numbers are displayed on the selected number display sections 50A to 50C.

The number-of-chips display section 51 of the bet display section 52 displays the chip mark 41 indicating the number of bet chips on the lottery number of three to six digits selected in the lottery number display section 50. The number displayed on the chip mark 41 indicates the number of chips bet. For example, as shown in FIG. 16, if three numbers of “12,” “21,” and “30” are displayed on the selected number display sections 50A to 50C and the chip mark 41 indicating “10” is displayed on the number-of-chips display section 51, it means that 10 chips are bet on the six-digit lottery number “122130.” Three lotteries are drawn with the roulette wheel 3 including the current lottery and if the composite win number of three to six digits provided by combining the three obtained win numbers and the lottery number completely match, the player gains so-called straight win and credit points of a predetermined amount is paid out to the player. Although they do not completely match, if the three component lottery numbers constitute the lottery number and the three component win numbers constitute the composite win number all match, the player gains so-called box win and credit points of a predetermined amount is paid out to the player.

In the straight win, a permutation between the plurality of symbols (numbers) on which the player bet and the plurality of win symbols (composite win numbers) matches. In the box win, a combination between the plurality of symbols (numbers) on which the player bet and the plurality of win symbols (composite win numbers) matches.

Next, the bet result display sections 53 will be discussed. The bet result display section 53 indicates information concerning the bet of the player with the win or loss result confirmed in the preceding game. FIG. 18 is a schematic drawing to show the bet result display section 53 of the second BET screen 133 according to the second embodiment.

The bet result display section 53 has a similar composition to that of the bet display section 52 and is provided with a lottery number display section 56 and a number-of-chips display section 57. Further, the bet result display section 53 is provided with a win result display section 58 for indicating whether or not the lottery number of three to six digits selected by the player in the lottery number display section 56 completely match the composite win number or whether or not the three component lottery numbers match the three component win numbers as the lottery results with the roulette wheel 3 to the left of the lottery number display section 56.

The lottery number display section 56 is provided with three display sections of a first selected number display section 56A, a second selected number display section 56B, and a third selected number display section 56C from the left to the right facing the liquid crystal screen 29. The lottery number formed by the three numbers previously selected by the player using the number selection section 44 are displayed on the selected number display sections 56A to 56C.

If the lottery number formed by the numbers on the selected number display sections 56A to 56C completely matches the composite win number formed by the win numbers as the lottery results with the roulette wheel 3 in the past three games (straight win), a character string 60 of “Win” is displayed on the win result display section 58. Further, award credit (odds) 59 responsive to the straight win, “X1000,” is displayed to the side of the character string 60 of “Win.”

Although the lottery number formed by the numbers on the selected number display sections 56A to 56C does not completely match the composite win number formed by the win numbers as the lottery results with the roulette wheel 3 in the past three games, if the three component lottery numbers match the three component win numbers (box win), the character string 60 of “Win” is displayed on the win result display section 58. Further, award credit (odds) 59 responsive to the box win, “XL100,” is displayed to the side of the character string 60 of “Win.”

If the lottery number does not match the composite win number and the three component lottery numbers do not match the three component win numbers either, a character string of “Lose” is displayed on the win result display section 58. In this case, award of credit is not given and as many bet chips as the number displayed on the number-of-chips display section 57 are lost.

The award credit (odds) 60 is determined according to an award table 61 stored in ROM 81. FIG. 19 is a drawing to show the award table according to the second embodiment.

As shown in FIG. 19R, the award credit (odds) paid out to the player according to the match type between the selected lottery number and the composite win number is uniquely determined in the award table 61. Specifically, if the lottery number of three to six digits selected by the player on the lottery number display section 56 completely matches the composite win number displayed on the result number display section 54 (straight win), credit of 1000 times as many bet chips of the player as the number in the number-of-chips display section 57 is paid out and is added to the current credit owned by the player. Although the lottery number does not completely match the composite win number, if the three component lottery numbers making up the lottery number match the three component win numbers making up the composite win number (box win), credit of 100 times as many bet chips of the player as the number in the number-of-chips display section 57 is paid out and is added to the current credit owned by the player. If the three component lottery numbers making up the lottery number do not match the three component win numbers making up the composite win number either (neither straight win nor box win), award of credit is not paid out to the player.

As described above, in the second embodiment, the player can switch between the first BET screen 131 provided with the usual table betting board 30 and the second BET screen 133 provided with the new number selection betting board 132 by pressing the screen switch button 34, 46.

In a roulette game using the second BET screen 133, the player can select three numbers among the numbers displayed on the number indication plates 14 of the roulette wheel 3 (38 numbers of “0,” “00,” and “1” to “36”) using the number selection section 44 to form the lottery number of three to six digits and can receive payout of credit based on the match type between the composite win number of three to six digits formed by combining the three win numbers provided as the three lottery results and the lottery number (straight or box), so that the player can play a new Numbers-type roulette game in addition to a usual roulette game in one roulette gaming machine 100 and the variety of game plays can be increased. In the Numbers-type game with the second BET screen 133, the credit payout is determined based on the three lottery results including the current lottery with the roulette wheel 3, so that the player can play a game with a sense of anticipation over a long time and can continue to have interest in the game.

In the roulette gaming machine 100, the ROM 81 (shown in FIG. 11) is provided with the award credit storage area 81A storing the odds concerning a usual roulette game using the first BET screen 131 and the award table storage area 81B storing the award table 61 storing the odds concerning a Numbers-type roulette game using the second BET screen 133 (see FIG. 19). As the odds for each BET area 42 of the first BET screen 131 stored in the award credit storage area 81A, an award of “X2” to “X36” is given depending on the bet method (straight up, corner bet, split bet, and the like). On the other hand, as the odds in the award table 61 stored in the award table storage area 81B, an award of “X100” to “X1000” is given depending on the match type between the lottery number and the composite win number as described above.

The RAM 82 (shown in FIG. 12) is provided with a bet information storage area 82A for storing the bet information of the player playing a game at present and a win number/composite win number storage area 82B for storing the win numbers of the roulette wheel 3 determined by the win determination unit 84 and the composite win number of three to six digits formed by the win numbers. The bet information specifically includes the BET areas 42 and the number of bet chips specified on the first BET screen 131 and the three numbers, the lottery number formed by the three numbers, and the number of bet chips specified on the second BET screen 32.

In the roulette gaming machine 100 described above, the roulette game (the first game) played by using the first BET screen 131 is provided by a game processing program substantially the same with the game processing program described above in the first embodiment with reference to FIG. 13. Therefore, detailed description for the processing of the roulette game is omitted herein.

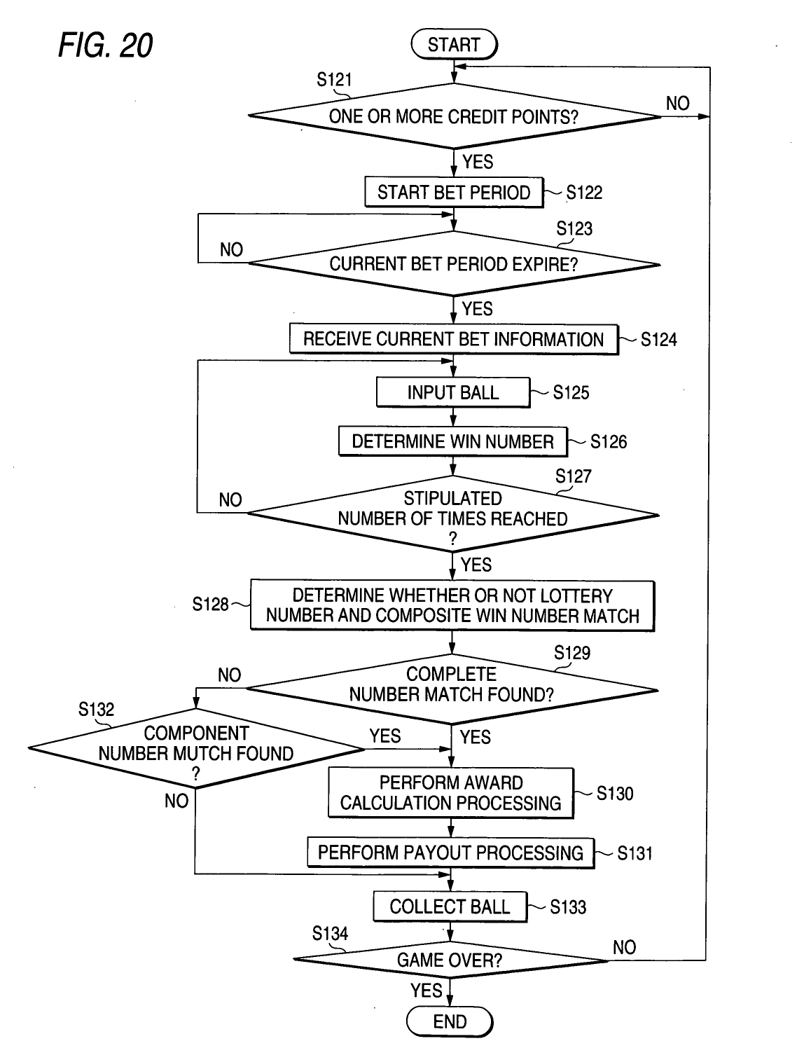

A game processing program for the Numbers-type roulette game (the second game) using the second BET screen 133 will be discussed. FIG. 20 is a flowchart of the game processing program for the Numbers-type roulette game using the second BET screen 133. The program shown in the flowchart of FIG. 20 is stored in the ROM 81 and the RAM 82 included in the roulette gaming machine 100 and is executed by the main control CPU 80.

First, at S121, the main control CPU 80 determines whether or not the player owns one or more credit points. In the roulette gaming machine 100 according to the second embodiment, when a medal or a coin is input into the medal acceptance unit 5 at any of the satellites 4, a medal input signal is sent from the satellite control section 90 of the satellite 4 to the main control section 83. According to the signal, the main control CPU 80 determines the input of the medal or the coin and increments the credit points owned by the player. The credit points incremented by the CPU 80 according to the number of input medals or coins, is recorded by the satellite control section 90 in the RAM 93 as the credit data indicative of the credit points. If no credit points is owned by the player (NO at S121), a wait mode is entered until the medal or the coin is input; if one or more credit points are owned by the player (YES at S121), the process proceeds to S122.

The second BET screen 133 shown in FIG. 16 is displayed on the image display 7 of the satellite 4 used by the player, enabling the player to bet a chip. Other players can enter the game at midpoint and the roulette gaming machine 100 according to the second embodiment allows a maximum of 10 players to play a game.

When the first player entering the game inputs a medal or a coin, the bet period in which each player can bet chip is started (S122). Unlike the usual roulette game, the Numbers-type roulette game allows the player to bet a chip in the next game immediately after the predetermined bet period expires.

Each player entering the game can operate the touch panel 28 during the bet period to select three numbers (for example, “6,” “30,” and “17”) for forming the lottery number of and bet his or her chip (see FIG. 16). The specific bet method using the second BET screen 133 is already described and therefore will not be discussed again.

Next, whether or not the current bet period expires is determined at S123. The current bet period is displayed with the BET timer graph 65. When the bet period in the preceding game expires, the red graph starts to extend to the right gradually. When the red graph extends to the rightmost side, the bet period in the current game expires.

Before the bet period expires (NO at S123), bet is accepted. If the bet period expires (YES at S123), a bet end signal is output to the satellite control sections 90 of all satellites 4 and an image to the effect that the current bet period expires is displayed on the liquid crystal screen 29 of each satellite 4. After this, the player is allowed to only perform bet operation in the next game. The current bet information of the player at each satellite 4 (specified three numbers, the lottery number including the specified numbers, and the number of bet chips on the lottery number) is received (S24) and is stored in the bet information storage area 82A of the RAM 82.

Next, the main control CPU 80 executes lottery processing with the roulette wheel 3 in accordance with a game execution program. First, at S125, the ball discharging unit 85 discharges the ball 16 into the roulette wheel 3. The discharged ball 16 rolls on the roulette wheel 3 along the guide wall 18. Then, when the rotation speed reduces and the centrifugal force is lost, the ball 16 rolls down the slope of the frame 11 and goes to the inside thereof and arrives at the rotating rotation disk 12 (see FIG. 2).

The ball 16 rolling to the rotation disk 12 is housed in any ball housing groove 13 through the tops of the number indication plates 14 outside the rotating rotation disk 12, and the number described on the number indication plate 14 corresponding to the ball housing groove 13 in which the ball 16 is housed (any of “0,” “00,” “1” to “36”) becomes the win number.

Subsequently, after the ball 16 is housed in the ball housing groove 13, the main control CPU 80 drives the win determination unit 84 for determining which number the ball is housed in the ball housing groove 13 corresponding thereto (S126).

Then, at S127, whether or not lottery processing has been performed a stipulated number of times is determined. In the second embodiment, three lotteries are drawn with the roulette wheel 3 for one game and three win numbers (for example, “17,” “6,” and “30”) are determined.

If lottery processing has not yet been performed the stipulated number of times (NO at S127), the process returns to S125 and the ball 16 is discharged and the next lottery is made.

On the other hand, if lottery processing has been performed the stipulated number of times (YES at S127), the process proceeds to S128.

At S28, whether or not the lottery number (for example, “63017”) formed by the three numbers selected by the player at each satellite 4 (for example, “6,” “30,” and “17”) match the composite win number (for example, “17630”) formed by the three win numbers provided as the lottery results (for example, “17,” “6,” and “30”) is determined from the bet information at the satellite 4 received at S124 and the three win numbers determined at S126. Then, the process proceeds to S129.

Whether or not the lottery number and the composite win number completely match at at least one satellite 4 is determined based on the number match determination at S128 (S129). If it is determined that the numbers match (YES at S129), the player gains a straight win and the main control CPU 80 executes award calculation processing (S130). In the award calculation processing, the win chip is recognized for each satellite 4 and the total award amount of credit paid out to the player at each satellite 4 is calculated using the award table 61 stored in the award table storage area 81B of the ROM 81. Subsequently, the process proceeds to S131.

At S131, credit payout processing is executed based on the award calculation processing at S130. To pay out credit to the player at the satellite 4, the main control section 83 outputs the credit data corresponding to the award amount to the satellite control section 90 of the satellite 4 of the winning player. The credit data is added to the RAM 93 of the satellite 4 of the winning player.

On the other hand, if it is determined that complete match between the lottery number and the composite win number is not found at any satellites 4 (NO at S129), the process proceeds to S132.

Subsequently, at S132, whether or not the three component lottery numbers constituting the lottery number match the three component win numbers constituting the composite win number is determined based on the number match determination at S128. If it is determined that the component lottery numbers match the component win numbers (YES at S132), the player gains a box win and the main control CPU 80 executes award calculation processing (S130). In the award calculation processing, the win chip is recognized for each satellite 4 and the total award amount of credit paid out to the player at each satellite 4 is calculated using the award table 61 stored in the award table storage area 81B of the ROM 81. Subsequently, at S131, credit payout processing is executed.

On the other hand, if it is determined that the component lottery numbers do not match the component win numbers at any satellites 4 (NO at S132), the process proceeds to S133.

At S133, the ball collection unit 86 installed below the rotation disk 12 collects the ball 16 on the rotation disk 12. The collected ball 16 will again be discharged to the roulette wheel 3 in the later game. After S133, the process proceeds to S134.

At S134, whether or not the player at at least one satellite 4 continues to play a game is determined. To quit playing another game, usually the player presses the payback button 23. If the payback button 23 is pressed, as many medals as the number responsive to the credit points owned by the player at present (usually, one medal per credit points) are paid back to the player from the medal payout opening 8.

If the player at any satellite 4 continues to play a game (NO at S134), the process returns to S121 and the player is again allowed to bet for another game.

On the other hand, if the players at all satellites 4 quit playing a game (YES at S133), the Numbers-type roulette game processing is terminated.

The usual roulette game played by the process of S1-S12 described with reference to FIG. 13 and the Numbers-type roulette game played by the process of S121-S134 are advanced on one roulette gaming machine 100 at the same time. That is, the player can switch the display screen between the first BET screen 131 and the second BET screen 133 by pressing the screen switch button 34, 46 displayed on the liquid crystal screen 29 and can play a Numbers-type roulette game by displaying the second BET screen 133 while playing a usual roulette game using the first BET screen 131.

As described above, the roulette gaming machine 100 according to the second embodiment enables the player to switch the display screen between the first BET screen 131 provided with the table betting board 30 like a usual betting table and the second BET screen 133 provided with the new number selection betting board 132 by pressing the screen switch button 34, 46.

In the roulette game using the second BET screen 133, the player can predict the lottery results in the three lotteries including the current lottery and select the lottery number of three to six digits with three numbers from among the numbers displayed on the number indication plates 14 of the roulette wheel 3 (38 numbers of “0,” “00,” and “1” to “36”) using the number selection section 44. Then, after lottery processing is performed three times with the roulette wheel 3, whether or not the selected lottery number matches the composite win number provided as the lottery results or whether or not the component lottery numbers constituting the lottery number match the component win numbers constituting the composite win number is determined, and credit is paid out based on the match type, so that the player can play the new Numbers-type roulette game on one roulette gaming machine 100. Therefore, the variety of game plays of the roulette gaming machine 100 can be increased and the player can continue to have interest in the game.

Further, in the Numbers-type roulette game using the second BET screen 133, credit award at a high ratio of 1000 times at the maximum is given to the player, so that the desire of the player to play a game can be increased.

The player can also bet a chip on the second BET screen 133 during the number lottery with the roulette wheel 3 after the bet period expires, so that the game play efficiency is enhanced.

Further, the player can also play a usual roulette game of predicting only the current win number on the first BET screen 131 using the table betting board 30 displayed by pressing the screen switch button 46, so that bet considering various player's wishes is made possible.

The invention is not limited to the specific embodiment described above and various improvements and modifications can be made without departing from the spirit and the scope of the invention.

For example, in the second embodiment, as for the bet method on the second BET screen 133, the player predicts the lottery results in the three lotteries including the current lottery and selects the lottery number including three numbers through the number selection section 44, but the number of selected numbers to form the lottery number is not limited to three and may be two or more. As the number of selected numbers increases, the number of the digits of the lottery number grows and the ratio of award to be paid out to the winning player (straight and box) can be made larger.

In the second embodiment, as for the Numbers-type roulette game using the second BET screen 133, the award ratio of payout of credit responsive to the number of identical number pairs is fixed according to the award table 61, but may be changed at random from one game to another.

In the second embodiment, screen display is switched between the first BET screen 131 and the second BET screen 133 as the player presses the screen switch button 34, 46, but the liquid crystal screen 29 may be divided into two parts of left and right parts or upper and lower parts for displaying the first BET screen 131 and the second BET screen 133 at the same time. This configuration enables the player to play two types of games at the same time without the need for operating the screen switch button 34, 46 for switching the screen.

As described above, according to the first embodiment, there is provided a gaming machine (for example, roulette gaming machine 1) including: a roulette wheel (for example, roulette wheel 3) on which a plurality of symbols are placed; a symbol lottery unit (for example, ball housing grooves 13 and ball 16) for drawing a win symbol from the plurality of symbols with the roulette wheel; and a betting section (for example, satellite 4) for a player to bet a chip predicting the lottery result of the symbol lottery unit, characterized in that the betting section includes a first symbol selection unit (for example, touch panel 28) for a player to select a plurality of first symbols from among the plurality of symbols, characterized by a first determination unit (for example, main control CPU 80 and S28), when the symbol lottery unit draws as many symbols as the number of the first symbols selected by the player through the first symbol selection unit, the first determination unit for determining how many of the first symbols match the win symbols provided as the lottery result; and a first payout unit (for example, main control CPU 80 and S30 and S31) for paying out credit points based on the number of the first symbols determined to match the win symbols by the first determination unit.

According to the configuration described above, the player selects a plurality of first symbols from among the symbols placed on the roulette wheel, how many of the first symbols selected match the win symbols provided as the lottery result with the roulette wheel, and a predetermined number of chips are paid out based on the number of the first symbols matching the win symbols, so that the player can be provided with a new Loto-type game based on the number of the selected symbols matching the win symbols while drawing lotteries with the roulette board like a conventional roulette board. In the new Loto-type game, payout of chips is determined by a plurality of lottery results with the roulette wheel, so that the player can play a game with a sense of anticipation over a long time and can continue to have interest in the game.

Further, a very large number of chip bet patterns are provided, so that the amount of chips paid out to the player as the game play result can be increased.

According to the first embodiment, the gaming machine (for example, roulette gaming machine 1) may be configured that the betting section (for example, satellite 4) includes a second symbol selection unit (for example, touch panel 28) for a player to select a second symbol from among the plurality of symbols, and that the gaming machine includes: a second determination unit (for example, main control CPU 80 and S7), when the symbol lottery unit draws one symbol, for determining whether or not the second symbol matches the win symbol provided as the lottery result; and a second payout unit (for example, main control CPU 80 and S9 and S10), for paying out credit points if the second determination unit determines that they match.

According to the configuration described above, the player selects a second symbol from among the symbols placed on the roulette wheel, whether or not the second symbol selected matches the win symbol provided as one lottery result with the roulette wheel, and a predetermined number of chips are paid out if they match. Thus, the gaming machine enables the player to play a usual roulette game of predicting only the current lottery result with the roulette wheel in addition to the new Loto-type game. Therefore, different types of games can be provided for the player based on lottery with one roulette wheel and various player's wishes can be satisfied.

According to the first embodiment, the gaming machine (for example, roulette gaming machine 1) may be configured that, the betting section (for example, satellite 4) includes: a screen display unit (for example, image display 7) for displaying either a first bet screen (for example, second BET screen 133) for the player to select the first symbol through the first symbol selection unit or a second bet screen (for example, first BET screen 131) for the player to select the second symbol through the second symbol selection unit; and a display switch unit (for example, screen switch button 34, 46) for switching the display screen between the first bet screen and the second bet screen displayed on the screen display unit.

According to the configuration described above, the betting section has the display unit for displaying the first bet screen for the player to select the first symbol or the second bet screen for the player to select the second symbol, so that the player can select any desired bet method and bet chips using the displayed bet screen. Further, the player can bet chips by switching the screen display between the screens, thereby advancing games at the same time based on the two types of bets for one roulette lottery. Therefore, the gaming machine increases the variety of game plays and enables the player to continue to have interest in the game.

According to the second embodiment, there is provided a gaming machine (for example, roulette gaming machine 100) including: a roulette wheel (for example, roulette wheel 3) on which a plurality of numbers are placed; a number lottery unit (for example, ball housing grooves 13 and ball 16) for drawing a win number from the plurality of numbers with the roulette wheel; and a betting section (for example, satellite 4) for a player to bet a chip predicting the lottery result of the number lottery unit, characterized in that the betting section includes a first number selection unit (for example, touch panel 28) for a player to select a lottery number of a plurality of digits resulting from combining a plurality of lottery numbers from among the plurality of numbers, characterized by first determination unit (for example, main control CPU 80 and S28), when the number lottery unit draws as many numbers as the number of the combined lottery numbers through the first number selection unit, the first determination unit for determining whether or not the lottery number matches the composite win number formed by combining a plurality of win numbers provided as the lottery results; and first payout unit (for example, main control CPU 80 and S30 and S31) for paying out credit points if the first determination unit determines that the lottery number matches the composite win number.

According to the configuration described above, the player selects the lottery number of a plurality of digits resulting from combining a plurality of numbers from among the numbers placed on the roulette wheel, whether or not the selected lottery number matches the composite win number of a plurality of digits provided as the lottery results with the roulette wheel is determined, and a predetermined number of chips are paid out if they match, so that the player can be provided with a new Numbers-type game based on the selected number match while drawing lotteries with the roulette board like a conventional roulette board. In the new Numbers-type game, payout of chips is determined by a plurality of lottery results with the roulette wheel, so that the player can play a game with a sense of anticipation over a long time and can continue to have interest in the game.

Further, a very large number of chip bet patterns are provided, so that the amount of chips paid out to the player as the game play result can be increased.

According to the second embodiment, the gaming machine (for example, roulette gaming machine 100) may further includes second determination unit (for example, main control CPU 80 and S28), if the first determination unit (for example, main control CPU 80 and S28) determines that the lottery number does not match the composite win number, for determining whether or not the component lottery numbers constituting the lottery number match the component win numbers constituting the composite win number; and second payout unit (for example, main control CPU 80 and S30 and S31) for paying out credit points if the second determination unit determines that the component lottery numbers match the component win numbers.

According to the configuration described above, although the selected lottery number does not match the composite win number of a plurality of digits provided as the lottery results with the roulette wheel, if the component lottery numbers constituting the lottery number match the component win numbers constituting the composite win number, a predetermined number of chips are paid out, so that the player can be provided with a new Numbers-type game based on the selected number match while drawing lotteries with the roulette board like a conventional roulette board. In the new Numbers-type game, payout of chips is determined by a plurality of lottery results with the roulette wheel, so that the player can play a game with a sense of anticipation over a long time and can continue to have interest in the game.

Further, a very large number of chip bet patterns are provided, so that the amount of chips paid out to the player as the game play result can be increased.

According to the second embodiment, the gaming machine (for example, roulette gaming machine 100) may be configured that the betting section (for example, satellite 4) includes a second number selection unit (for example, touch panel 28) for a player to select a lottery number from among the plurality of numbers, and the gaming machine further includes: a third determination unit (for example, main control CPU 80 and S7), when the number lottery unit draws one number, for determining whether or not the lottery number matches the win number provided as the lottery result; and a third payout unit (for example, main control CPU 80 and S9 and S10) for paying out credit points if the third determination unit determines that they match.

According to the configuration described above, the player selects a lottery number from among the numbers placed on the roulette wheel, whether or not the selected lottery number matches the win number provided as one lottery result with the roulette wheel, and a predetermined number of chips are paid out if they match. Thus, the gaming machine enables the player to play a usual roulette game of predicting only the current lottery result with the roulette wheel in addition to the new Numbers-type game. Therefore, different types of games can be provided for the player based on lottery with one roulette wheel and various player's wishes can be satisfied.

According to the second embodiment, the gaming machine (for example, roulette gaming machine 100) may be configured that the betting section (for example, satellite 4) includes a screen display unit (for example, image display 7) for displaying either a first bet screen (for example, second BET screen 133) for the player to select the lottery number through the first number selection unit or a second bet screen (for example, first BET screen 131) for the player to select the lottery number through the second number selection unit; and display switch unit (for example, screen switch button 34, 46) for switching the display screen between the first bet screen and the second bet screen displayed on the screen display unit.

According to the configuration described above, the betting section has the display unit for displaying the first bet screen for the player to select the lottery number or the second bet screen for the player to select the single lottery number, so that the player can select any desired bet method and bet chips using the displayed bet screen. Further, the player can bet chips by switching the screen display between the screens, thereby advancing games at the same time based on the two types of bets for one roulette lottery. Therefore, the gaming machine increases the variety of game plays and enables the player to continue to have interest in the game.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A gaming machine comprising:
a roulette wheel on which a plurality of symbols are arranged;
a symbol lottery unit that draws a lottery to determine a win symbol from among the symbols arranged on the roulette wheel;
a betting section that allows a player to bet on at least one of the symbols arranged on the roulette wheel;
a first game processing unit that provides a first game of a roulette game to the player, the first game processing unit determining whether or not the symbol on which the player bet with the betting section matches with the win symbol determined by the symbol lottery unit in a single round of the lottery; and
a second game processing unit that provides a second game different from the first game to the player, the second game being played in accordance with the symbol on which the player bet with the betting section and the win symbol determined by the symbol lottery unit.

2. The gaming machine according to claim 1, wherein the betting section includes a first payout unit that pays out a predetermined amount of a credit points to the player when the first game processing unit determines that the symbol on which the player bet with the betting section matches with the win symbol.

3. The gaming machine according to claim 2, wherein the betting section allows the player to bet desired amount of the credit points owned by the player on at least one of the symbols arranged on the roulette wheel.

4. The gaming machine according to claim 3, wherein the betting section includes a game media acceptance unit that accepts game media input by the player, the game media depending on which a predetermined amount of the credit points are added to the credit points owned by the player.

5. The gaming machine according to claim 1, wherein the betting section includes a display unit that displays a first game screen for allowing the player to play the first game and a second game screen for allowing the player to play the second game.

6. The gaming machine according to claim 5, wherein the betting section includes a display switch unit that allows the player to selectively switch the display unit to display one of the first game screen and the second game screen.

7. The gaming machine according to claim 1, wherein the betting section allows the player to bet on a plurality of symbols arranged on the roulette wheel, and
wherein the second game processing unit determines a match status between the plurality of symbols on which the player bet with the betting section and a plurality of win symbols determined by the symbol lottery unit in a plurality of rounds of the lottery.

8. The gaming machine according to claim 7, wherein the betting section includes a second payout unit that pays out a predetermined amount of a credit points to the player in accordance with the match status determined by the second game processing unit.

9. The gaming machine according to claim 8, wherein the betting section allows the player to bet desired amount of the credit points owned by the player on each of the plurality of symbols.

10. The gaming machine according to claim 9, wherein the betting section includes a game media acceptance unit that accepts game media input by the player, the game media depending on which a predetermined amount of the credit points are added to the credit points owned by the player.

11. The gaming machine according to claim 7, wherein the second game processing unit determines a number of matches between the plurality of symbols on which the player bet and the plurality of win symbols, as the match status.

12. The gaming machine according to claim 7, wherein the second game processing unit determines whether or not a permutation between the plurality of symbols on which the player bet and the plurality of win symbols, as the match status.

13. The gaming machine according to claim 7, wherein the second game processing unit determines whether or not a combination between the plurality of symbols on which the player bet and the plurality of win symbols, as the match status.

14. The gaming machine according to claim 1, wherein a number of the roulette wheel provided in the gaming machine is one.

15. The gaming machine according to claim 1, wherein a plurality of the betting sections are provided in the gaming machine.

16. A gaming method comprising:
drawing a lottery to determine a win symbol from among a plurality of symbols arranged on a roulette wheel;
allowing a player to bet on at least one of the symbols arranged on the roulette wheel;
providing a first game of a roulette game to the player, the first game being played by determining whether or not the symbol on which the player bet matches with the win symbol; and
providing a second game different from the first game to the player, the second game being played in accordance with the symbol on which the player bet and the win symbol.
